(19) United States
(12) Patent Application Publication
(10) Pub. No.: US 2009/0254373 A1
(43) Pub. Date: Oct. 8, 2009

(54) METHODS AND APPARATUS FOR COMMUNICATING WITH CHIROPRACTIC PATIENTS

(75) Inventors: Jason Dee Shields, Voss (NO); Siv Jossang Sheilds, Voss (NO)

Correspondence Address: K&L Gates LLP, P.O. Box 1135, CHICAGO, IL, 60690, US

(73) Assignee: MY SPINE TIME AS, Voss (NO)

(21) Appl. No.: 12/366,749

(22) Filed: Feb. 6, 2009

Related U.S. Application Data
(60) Provisional application No. 61/026,629, filed on Feb. 6, 2008.

(51) Int. Cl. G06Q 50/00; G06Q 30/00

(52) U.S. Cl. 705/3; 705/2; 705/30; 705/26

(57) ABSTRACT

Methods and apparatus for communicating with chiropractic patients are disclosed. A hosting company sells a chiropractor a membership that includes a predetermined number of downloads of a patient wellness break software application. The chiropractor then gives access code(s) to patients and/or prospective patients for free that allows them to download the wellness break software. The software enables the delivery of wellness articles, wellness breaks, health tips and/or other information. Each patient sets up his/her user profile including time slots indicating when and where the user wants to receive wellness communications. For example, a health tip may include a picture (e.g., of a person sitting up straight with their arms and fingers in a particular position), a caption (e.g., “Sit up straight with your arms in a V-shape and your thumbs back for ten seconds.”), and an additional tip (e.g., “Did you know drinking water . . . ”). The health tip may be generic or patient specific based on input from the associated chiropractor.

### PRIORITY CLAIM

This application claims the benefit of U.S. Provisional Patent Application No. 61/026,629, filed Feb. 6, 2008, entitled “Methods and Apparatus for Communicating with Chiropractic Patients,” the entire contents of which are hereby incorporated by reference.

### TECHNICAL FIELD

The present disclosure relates in general to chiropractic treatment, and, in particular, to methods and apparatus for communicating with chiropractic patients.

### BRIEF DESCRIPTION OF THE DRAWINGS

FIG. 1 is a high level block diagram of an example communications system.

FIG. 2 is a more detailed block diagram showing one example of a computing device.

FIG. 3 is a flowchart of an example process to communicate with chiropractic patients.

FIG. 4 is a screenshot of an example desktop pop-up message to a chiropractic patient.

FIGS. 5-15 are screenshots of an example web site for doctors.

FIGS. 16-30 are screenshots of an example web site for administrators.

FIGS. 31-34 are block diagrams illustrating example system functionality.

FIGS. 35-39 are examples of marketing materials.

### DETAILED DESCRIPTION OF EXEMPLARY EMBODIMENTS

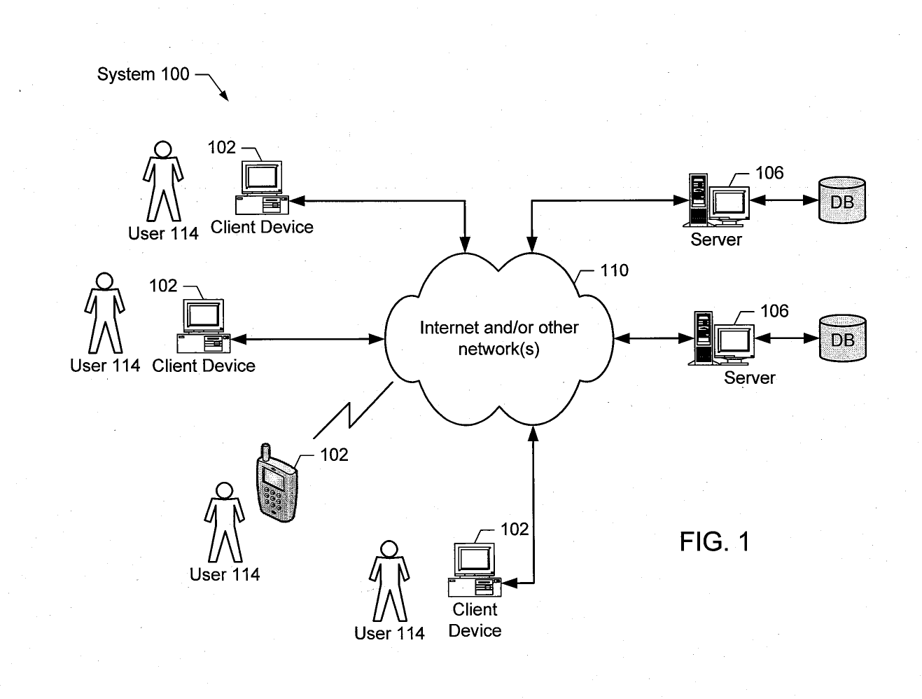

The present system is most readily realized in a network communications system. A high level block diagram of an exemplary network communications system 100 is illustrated in FIG. 1. The illustrated system 100 includes one or more client devices 102, one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores chiropractic communication data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

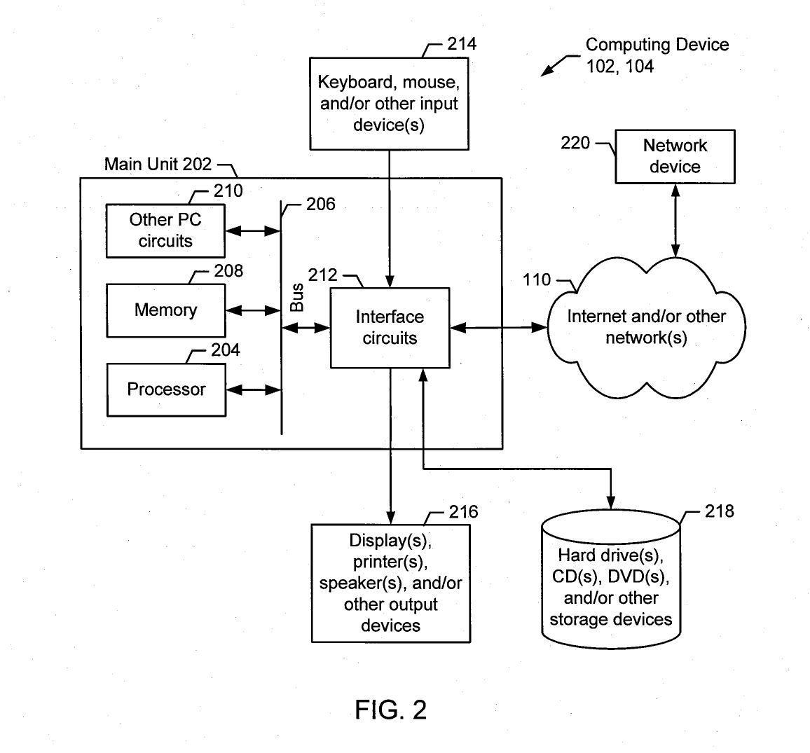

A more detailed block diagram of the electrical systems of a computing device (e.g., client device 102 and/or server 106) is illustrated in FIG. 2. Although the electrical systems of a client device 102 and a typical server 106 may be similar, the structural difference between the two types of devices are well known.

The client device 102 may include a personal computer (PC), a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the client device 102. For example, the display 216 may be used to display web pages and/or desktop pop-up data received from the server 106. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the client device 102.

The client device 102 may also exchange data with other network devices 220 via a connection to the network 110. The network connection may be any type of network connection, such as an Ethernet connection, digital subscriber line (DSL), telephone line, coaxial cable, etc. Users of the system 100 may be required to register with the server 106. In such an instance, each user may choose a user identifier (e.g., e-mail address) and a password which may be required for the activation of services. The user identifier and password may be passed across the network 110 using encryption built into the user's browser. Alternatively, the user identifier and/or password may be assigned by the server 106.

Client devices 102 may connect to the server 106 to access data and view or generate reports. Access to the server 106, databases and reports can be controlled by appropriate security software or security measures. An individual member's access can be defined in the system and limited to certain data, information and reports. Access to non-authorized data, information and reports, such as another individual's investment information or aggregated investment information, can be prohibited.

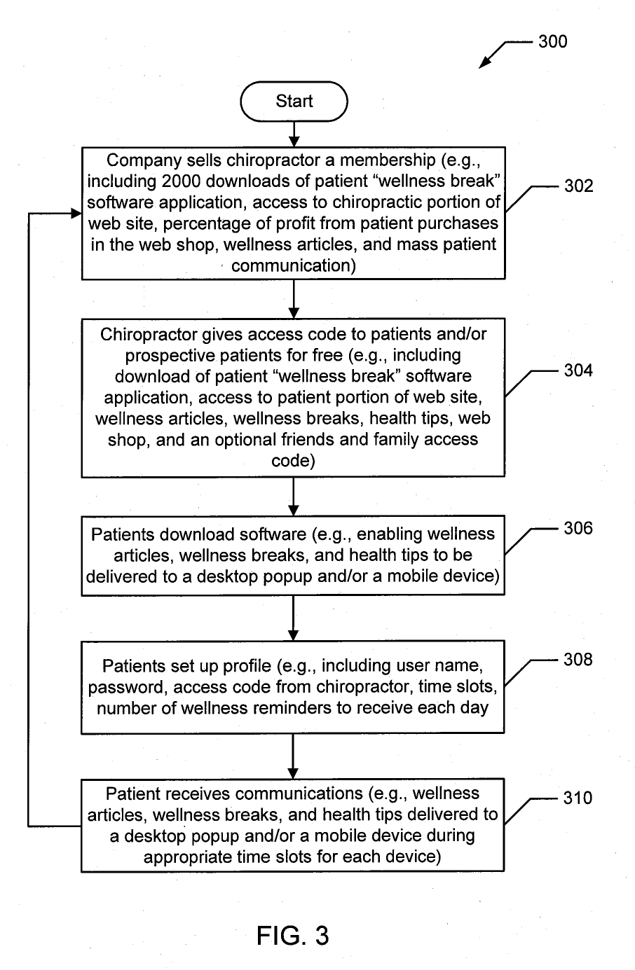

A flowchart of an example process 300 for communicating with chiropractic patients is illustrated in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and many of the steps described are optional.

The process 300 begins when the hosting company sells a chiropractor a membership (block 302). The membership preferably includes a predetermined number of downloads of a patient “wellness break” software application, access to chiropractic portion of web site, a percentage of profits from patient purchases in a web shop, wellness articles, and mass patient communication (e.g., though email and/or through SMS messaging).

The chiropractor then gives the access code(s) to patients and/or prospective patients for free (block 304). A patient or a prospective patient with a valid access code may receive a download of the patient “wellness break” software application, access to patient portion of web site, wellness articles, wellness breaks, health tips, web shop access, and an optional friends and family access code. Each access code identifies the associated chiropractor via a database lookup, and each access code may also be unique to each patient.

Each patient and/or prospective patient then downloads the software (block 306). The software enables the delivery of wellness articles, wellness breaks, health tips and/or other information. Delivery of the information may be to a web page, a desktop popup, and/or a mobile device. Preferably, data is delivered to the desktop popup in the back ground as part of the client device's operating system. Delivery to a mobile device may be accomplished using any suitable protocol, such as MMS and/or SMS.

Once the software is downloaded, each patients sets up his/her user profile (block 308). The user profile may include a user name, a password, the access code received from the chiropractor, time slots indicating when (e.g., week days, evenings, etc.) and where (desktop, mobile device, etc.) the user wants to receive wellness reminders, the number of wellness reminders to receive each day, etc.

Each patient then begins receiving wellness communications (block 310). The wellness communications may include wellness articles, wellness breaks, and health tips delivered to a desktop popup and/or a mobile device during appropriate time slots for each device. For example, a health tip may include a picture (e.g., of a person sitting up straight with their arms and fingers in a particular position), a caption (e.g., “Sit up straight with your arms in a V-shape and your thumbs back for ten seconds.”), and an additional tip (e.g., “Drink half of your weight (pounds) in ounces of water daily.”, “Avoid white flour.”, “Think positive.”). The health tip may be generic or patient specific based on input from the associated chiropractor.

Health tips may also include long messages such as “Move More. Make it a daily challenge to find ways to move your body. Climb stairs if given a choice between that and escalators or elevators. Walk your dog; chase your kids; toss balls with friends, mow the lawn. Anything that moves your limbs is not only a fitness tool, it's a stress buster. Think ‘move’ in small increments of time. It doesn't have to be an hour in the gym or a 45-minute aerobic dance class or tai chi or kickboxing. But that's great when you're up to it. Meanwhile, move more. Thought for the day: Cha, Cha, Cha . . . Then do it!”

Wellness articles may be even longer than health tips. The following is an example wellness article:

### Happy Feet

Feet are abused. Day in and day out we demand incredible things from our five-toed friends. We walk, we run, we cycle, we stand, we jump and we kick. We also cram them into finely pointed dress shoes, precariously balance them on platform shoes, and punish them in our work boots. Poor feet.
I often explain to the massage therapists that a good foot massage will create clients for life. Since we not only abuse our feet but we also tend to ignore them, it isn't until someone else pays any attention to them that we realize how good it feels to us when our feet are happy. Unfortunately, sometimes we let the damage continue until real problems arise . . . sprained ankles, shin splints, stress fractures, bunions, calluses, corns, hammer toes, arthritis and the list goes on.
Let's take a quick look at how these feet are built. Fourteen bones make up the toes alone with joints found in between each. Five long bones make up the top part of your foot and those meet seven bones that make up your ankle. All the bones are held together at the joints by connective tissues like ligaments and joint capsules. Muscles and tendons cross the foot on all sides and on different angles to help control movement of the foot. Together, this system of bones, muscles, and other tissues create what is known as a “flexible tripod”.
The heel (known as the calcaneus) makes up the rear of the tripod while the ball of the foot at the great toe and at the 5th or smallest toe makes up the other two points of the tripod. Just like a stool with three legs is more stable than a stool with one or two legs, this tripod design provides for a balanced foundation. Thanks to the mobility provided by the joints and the support of all the soft tissues like the muscles and ligaments, the tripod is able to absorb shock kind of like a spring. Together, when all of the angles, positions, and forces are within normal limits the feet can be sturdy, strong and resilient while also providing intricate balance, sensitivity and control.
So what does it take to keep this intimate network of body parts in the foot happy? Here are some good ideas:
   Wear comfortable shoes with appropriate support for the bottom or the arch of the foot. Allowing this arch to flatten over time can create mechanical problems and pain.
      Massage your feet with a tennis ball or round dowel of wood as you sit during the day. Roll the ball from the heel to the ball of the foot with comfortably firm pressure. This will help keep the foot supple and increase the circulation in the legs.
      Keep the feet clean and allow them to breathe as often as possible. Wear clean socks appropriate for the activity or work you are doing.
      Keep the feet well manicured, massaged by a therapist if necessary, and examined by a chiropractor for any possible mechanical problems. Make sure the arches are equal on both sides and that at least 2 fingers will slide underneath past the first knuckle.
The feet are not only important in and of themselves. Improper care and function of the feet can lead to knee problems, hip problems, and low back or spinal problems. Correcting for foot abnormalities through chiropractic care, the use of orthotics (shoe inserts), massage therapy, etc., can not only keep you dancing on happy feet, but can also improve the life of everything else those feet have to carry. After all, everyone's health could use a good foundation.

Wellness communications and/or health tips may also include exercises (e.g., literally and/or via a hyperlink). Example exercises and corresponding serial numbers include:

Neck

ccc00011
Sit up straight. Bend your head to each side, using the hand on the same side to gently pull your ear toward your shoulder.

ccc00020
Sit up straight in your chair. Breathe deeply. Bend your head to each side and back (chin toward your shoulder), using the hand on the same side to gently increase the stretch.

Hands

aaa0182
Breathe deeply. Smile. With your arms at your side, elbows bent and palms facing downward clench your fists then stretch your fingers wide.

aaa0181
Take a deep breath and blow it out fully. With your arms at your side, elbows bent and palms facing downward, shake your hands out.

Face

aaa0276
With your head held high, facing straight ahead and smiling, squeeze your eyes shut, then open them wide.
   aaa0281
With your head held high, facing straight ahead and smiling, squeeze your eyes shut, then open them wide.

Thoracic

aaa0356
Take a deep breath and smile. Sitting up straight in your chair, hands on your thighs, take a deep breath and blow it out. Repeat.

aaa0365
Smile. Sitting up straight in your chair, face straight ahead and raise your arms, one at a time, over your head, reaching toward the ceiling and stretching your shoulders.

Shoulders

aaa0387
Smile. Sit up straight in your chair, facing straight ahead. With your arms at your sides, rotate your shoulders in big circles forward five times, then backward five times.

aaa0392
Take a deep breath and smile. Sit up straight in your chair, facing straight ahead. With your arms at your sides, rotate your shoulders, one after the other, in big circles forward five times, then backward five times.

Thoracic+Lumbar

eee0527
Breathe deeply. Sitting straight in your chair, facing straight ahead, raise your arms to shoulder level. Reach across your body and grasp both shoulders. Keeping your feet flat on the floor, bend forward and rotate your body to the right and then to the left.

eee0528
Breathe deeply and smile. Sitting straight in your chair, facing straight ahead, raise your arms to shoulder level. Reach across your body and grasp both shoulders. Keeping your feet flat on the floor, bend forward and rotate your body to the right and then to the left.

Legs

ccc00055
Take a deep breath and smile. Sitting upright in your chair with feet flat on the floor, place your hands comfortably on your thighs. Slide one foot backwards, keeping your heel on the floor as long as possible, feeling the stretch in your calf. Repeat on the other side.

aaa0547
Breathe deeply. Sit upright in your chair with your knees shoulder width apart and your feet fiat on the floor. Keeping your back straight, place your hands on the inside of your knees and press outward, resisting with your thighs.

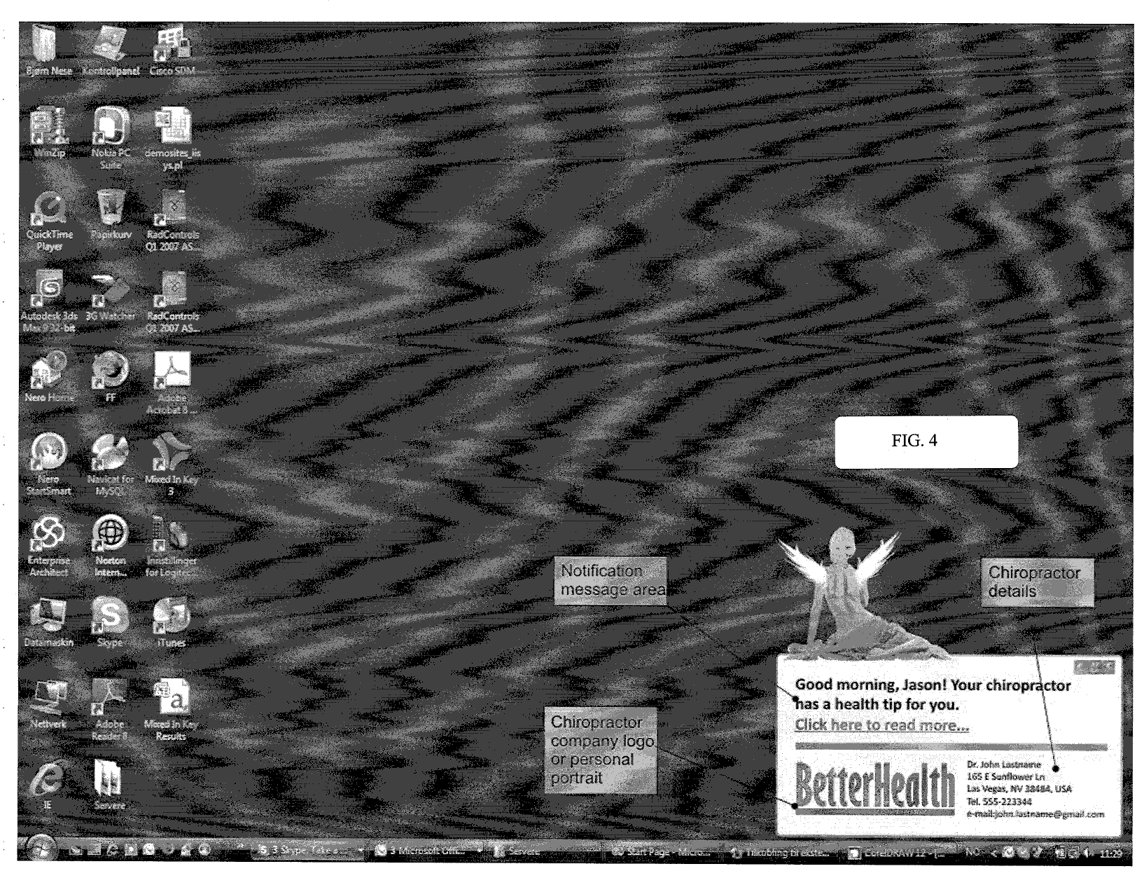

FIG. 4 is a screenshot of an example pop-up message to a chiropractic patient. In this example, the pop-up message includes a notification area. This notification area includes a hyperlink to read a health tip. Any area of the pop-up may include such a hyperlink. Preferably, the health tip includes a picture portion and a text portion. The picture portion illustrates at least one human body position with a drawing and/or a photograph. The text portion describes the at least one body position.

The pop-up may also be customized by the server and/or the wellness break software to include a chiropractor company logo, personal photo, and/or chiropractor details such as his/her contact information. In this example, the pop-up is delivered to the personal computing device in the back ground as part of the personal computing device's operating system.

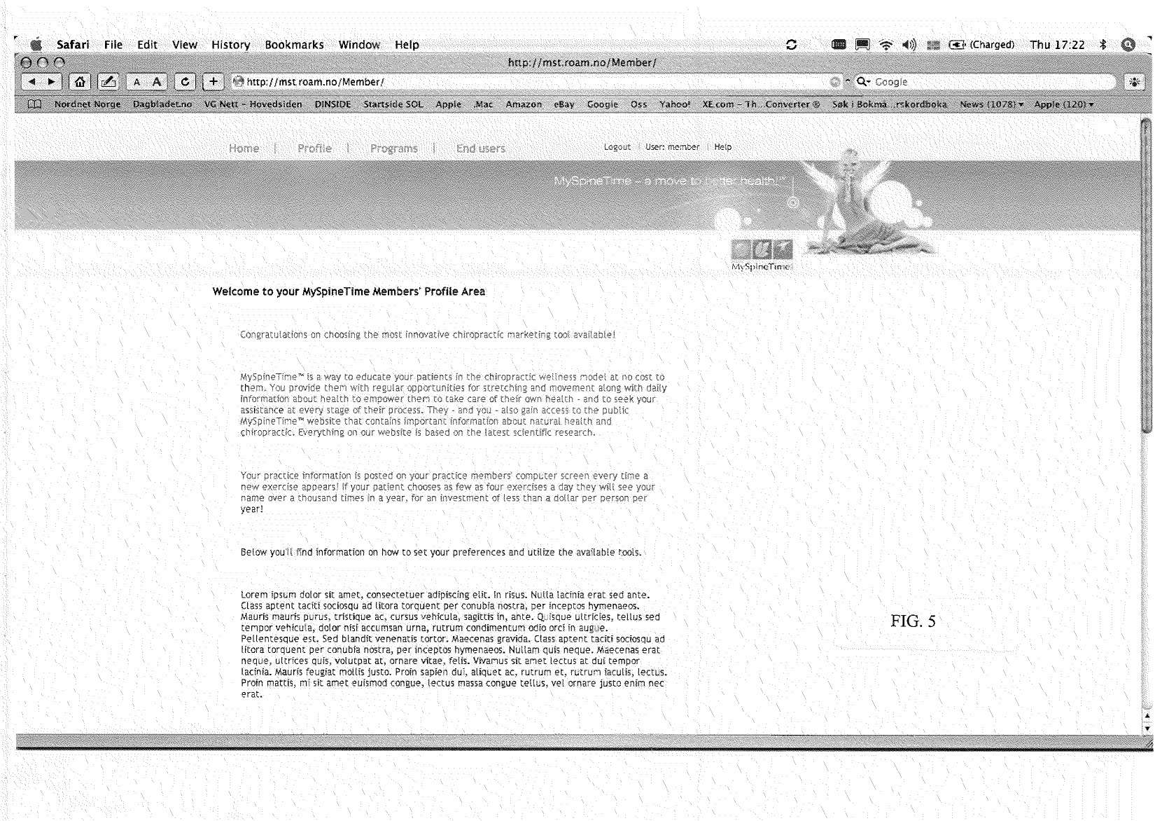

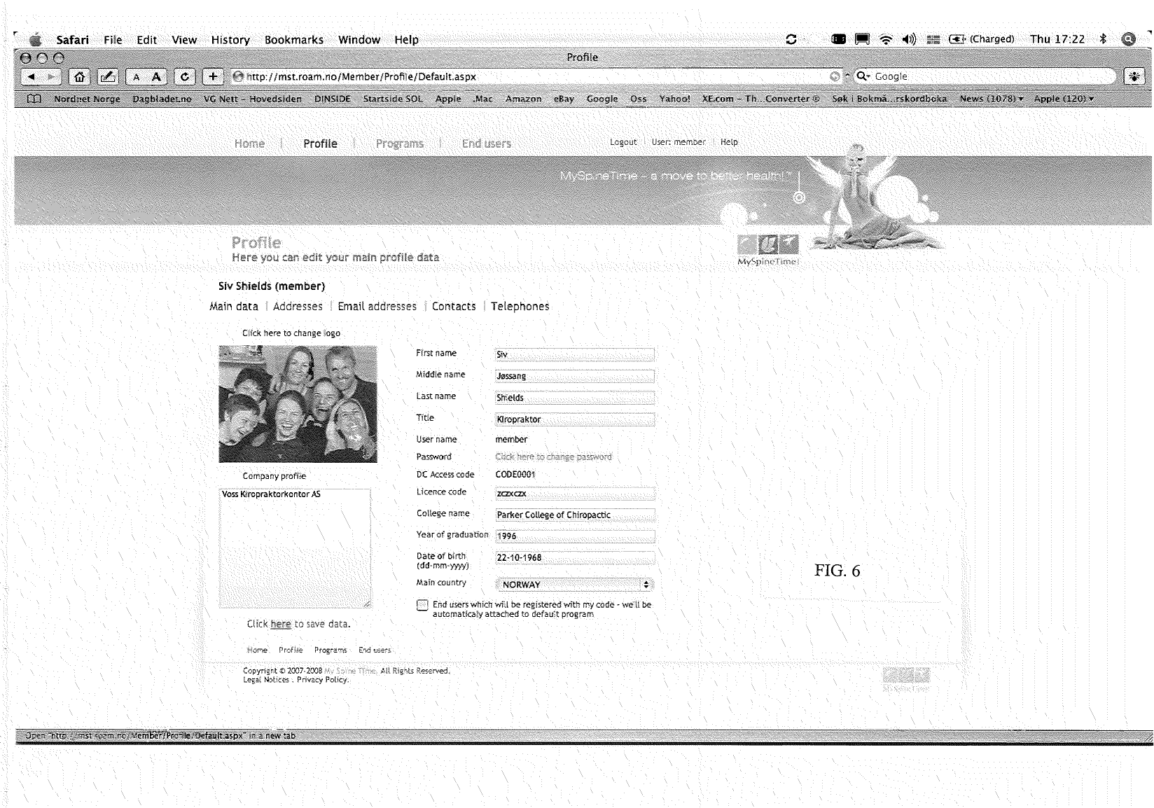

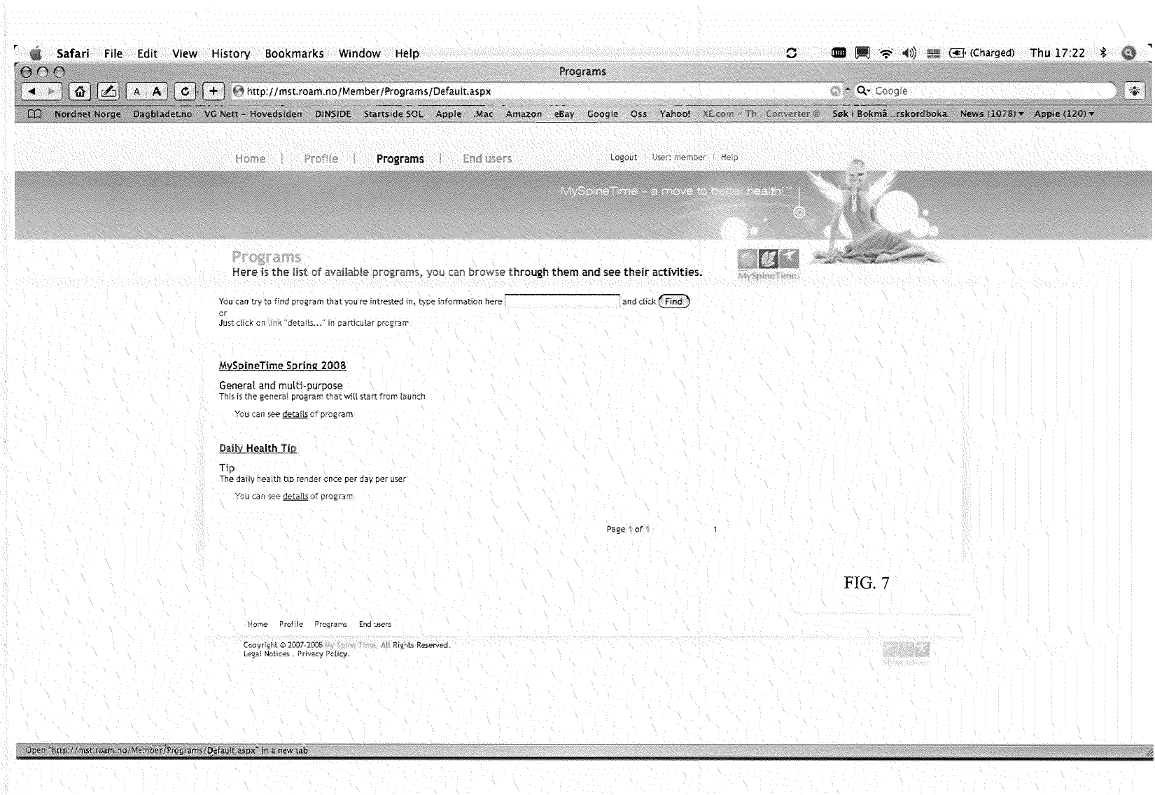

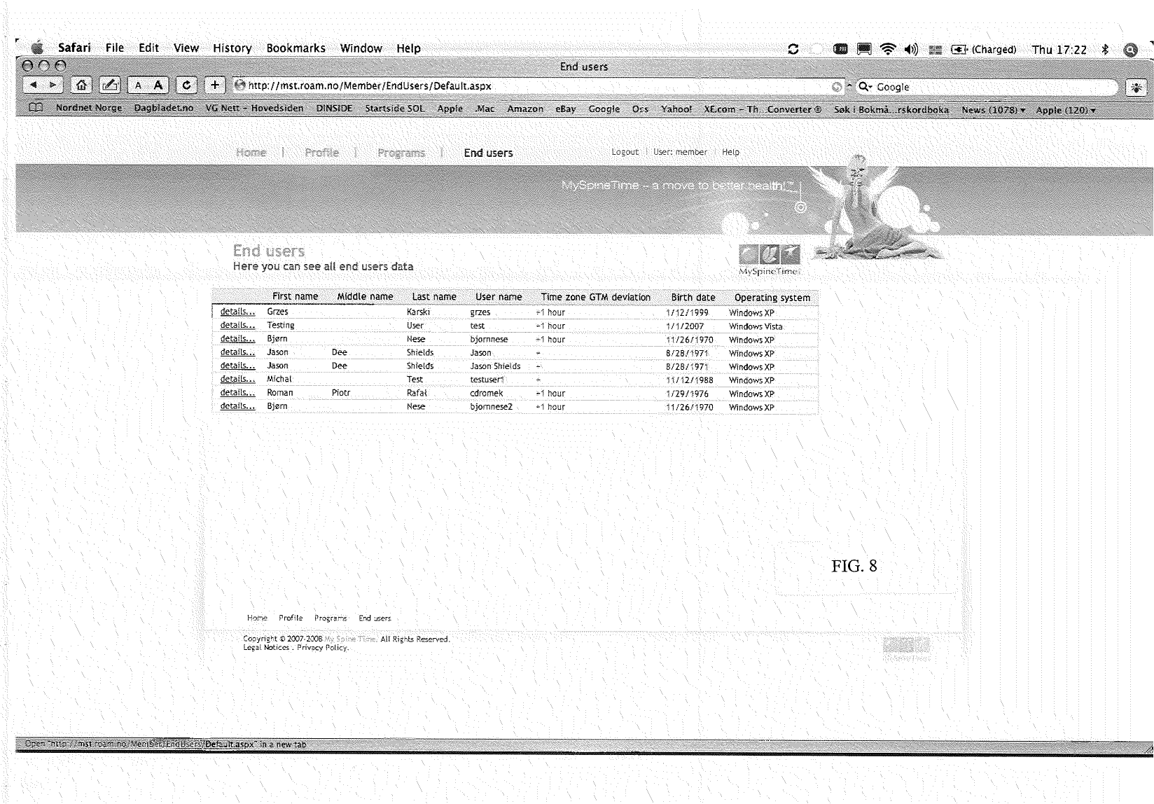

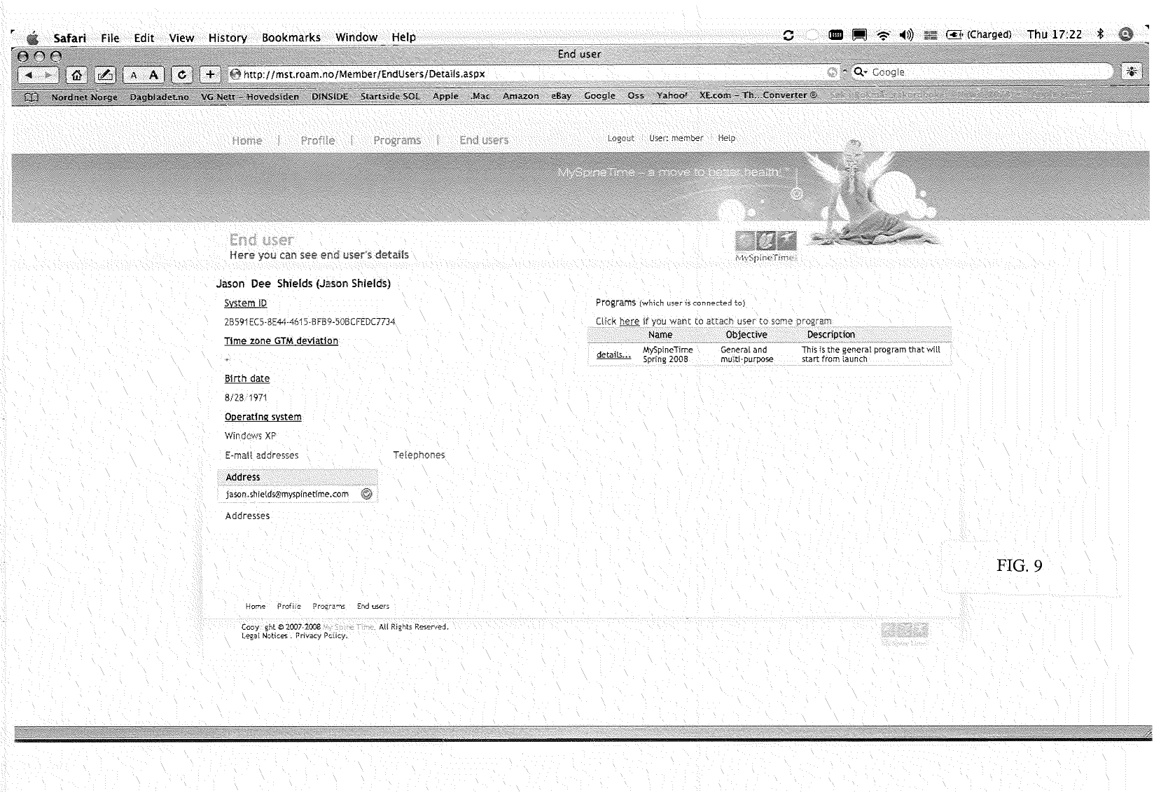

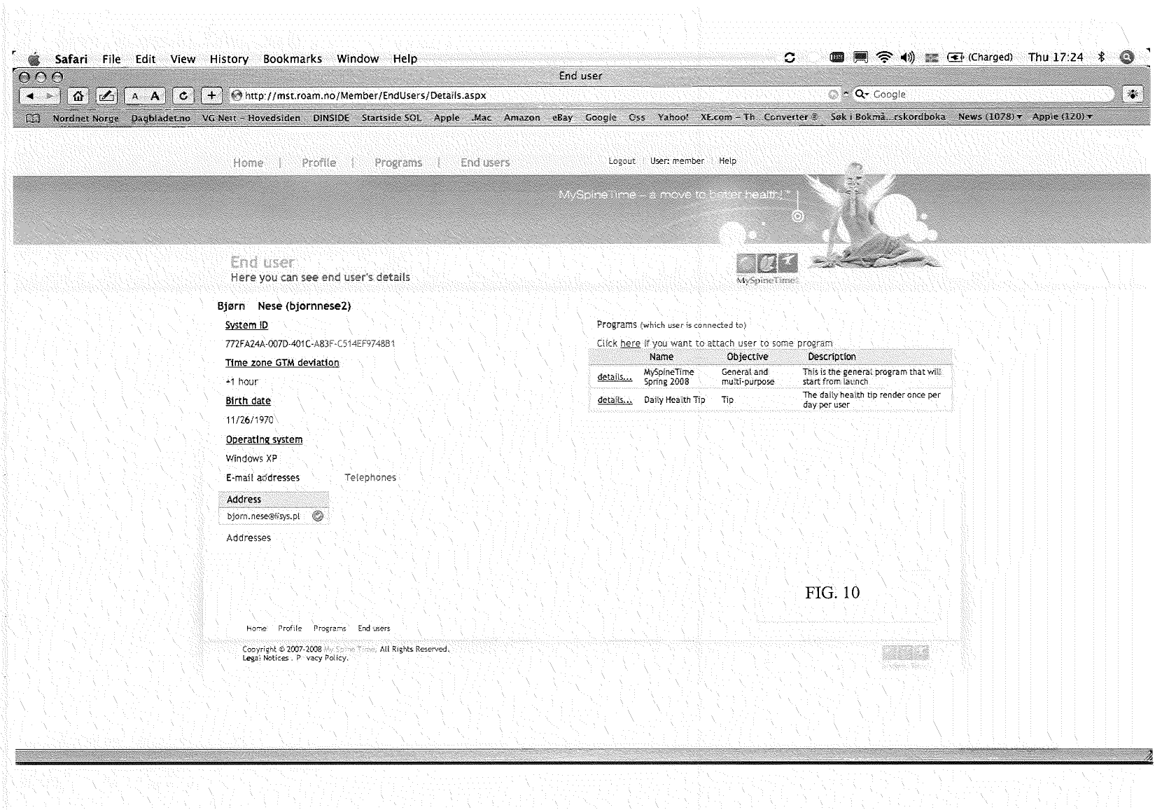

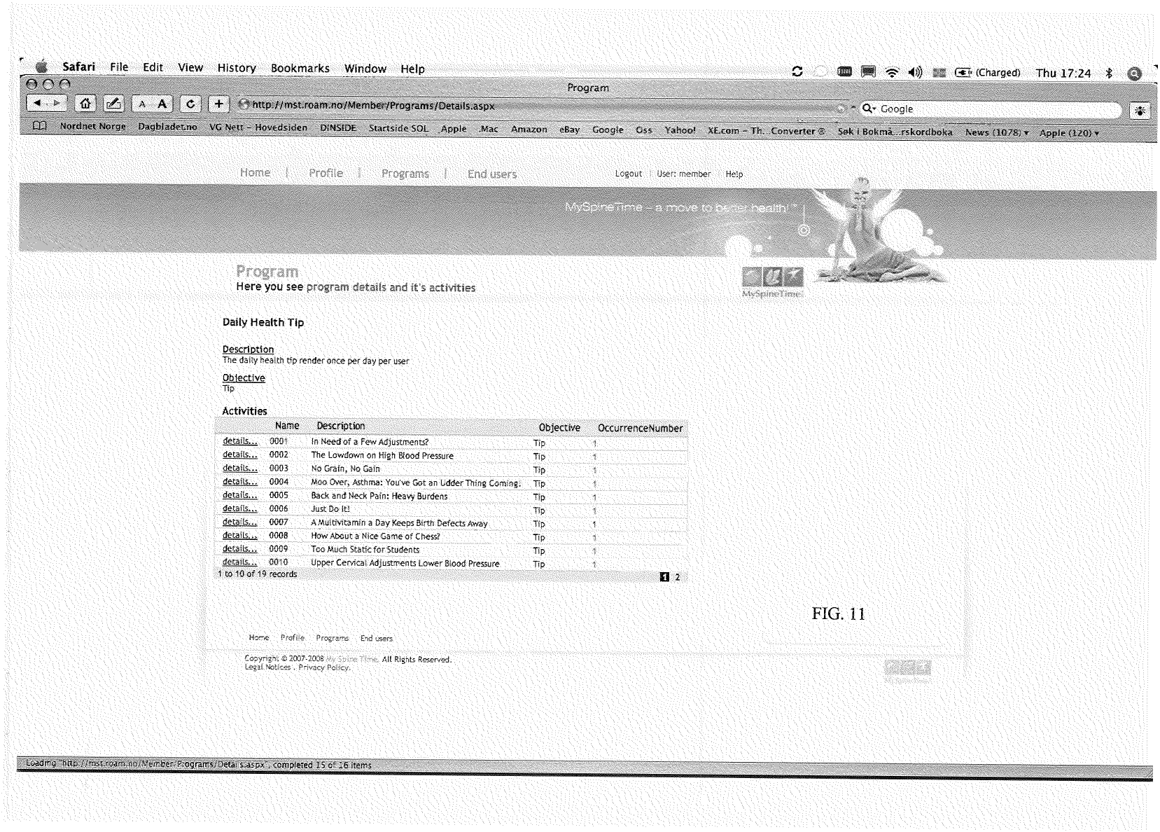

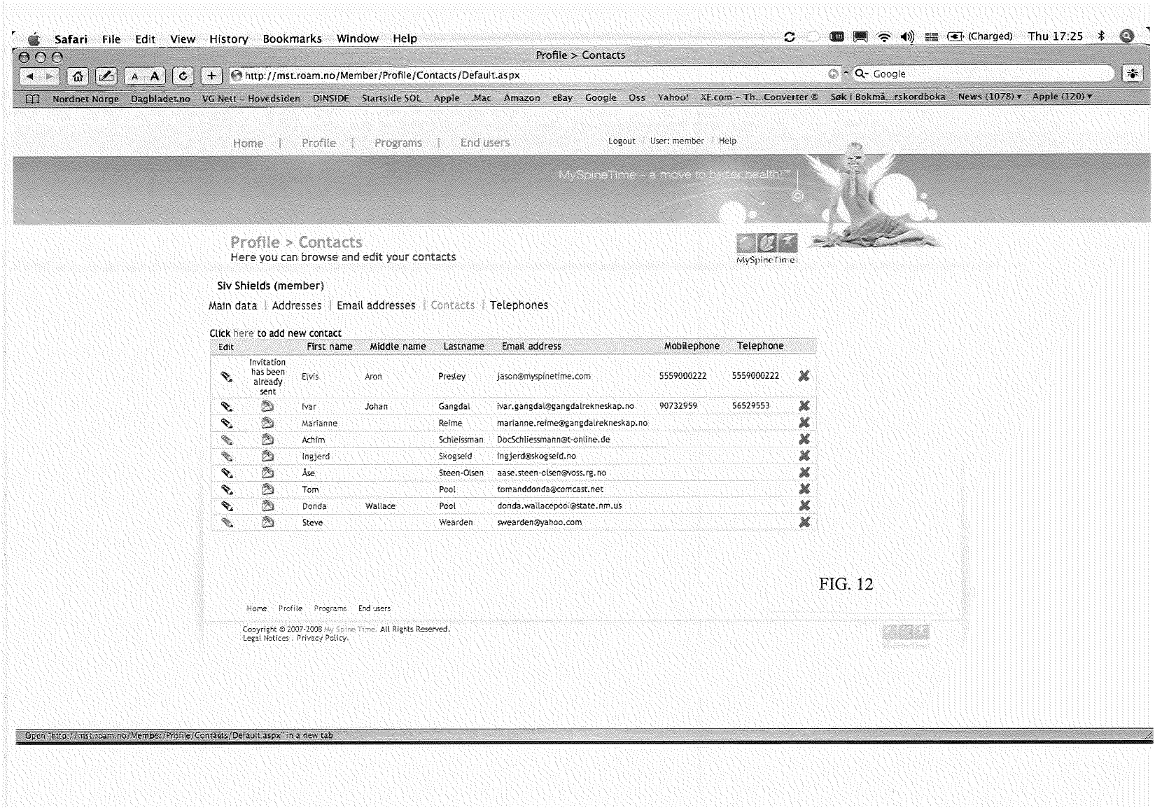

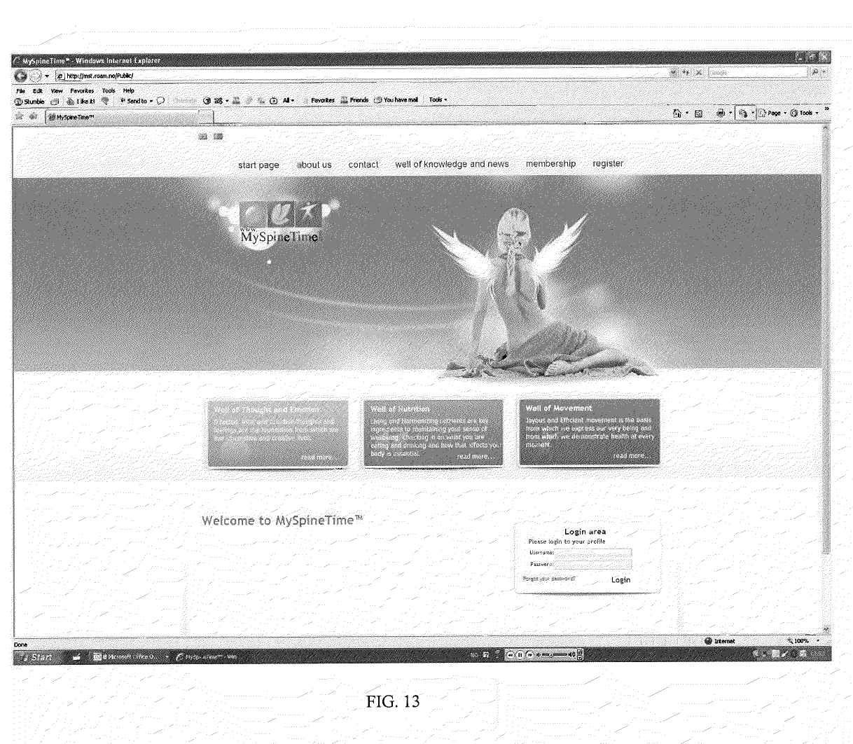

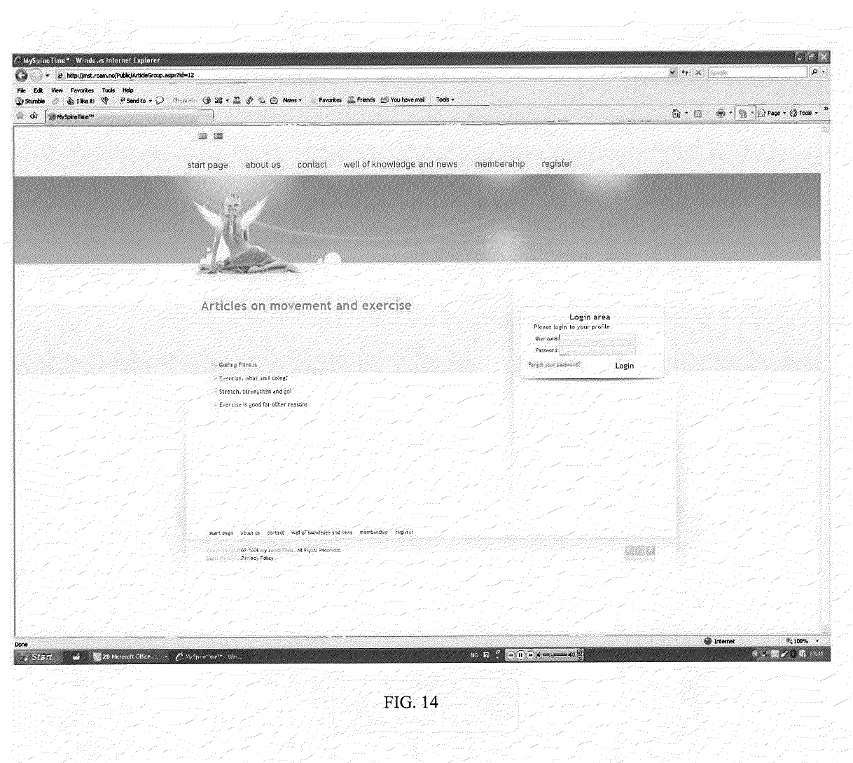

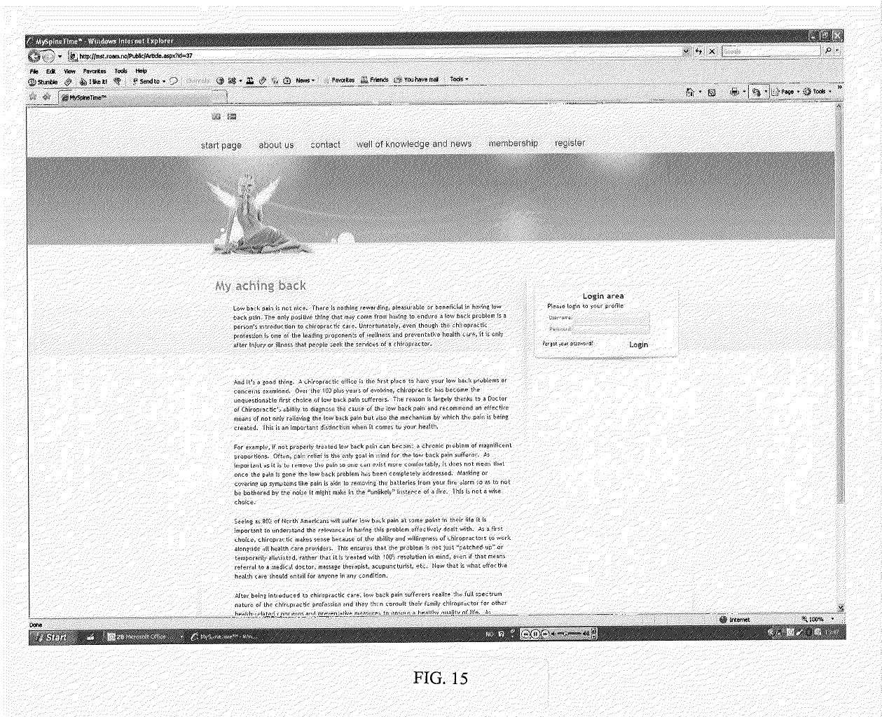

FIGS. 5-15 are screenshots of an example web site for doctors such as chiropractors. Each doctor may edit his/her profile information including the company logo, personal photo, and/or chiropractor details such as his/her contact information. Some or all of this profile information may then be used to customize messages to that doctor's patients. In addition, each doctor may choose which programs he/she wants to participate in as well as view and modify patient data such as how to communicate with a particular patient including what types of information to send and how often to that information.

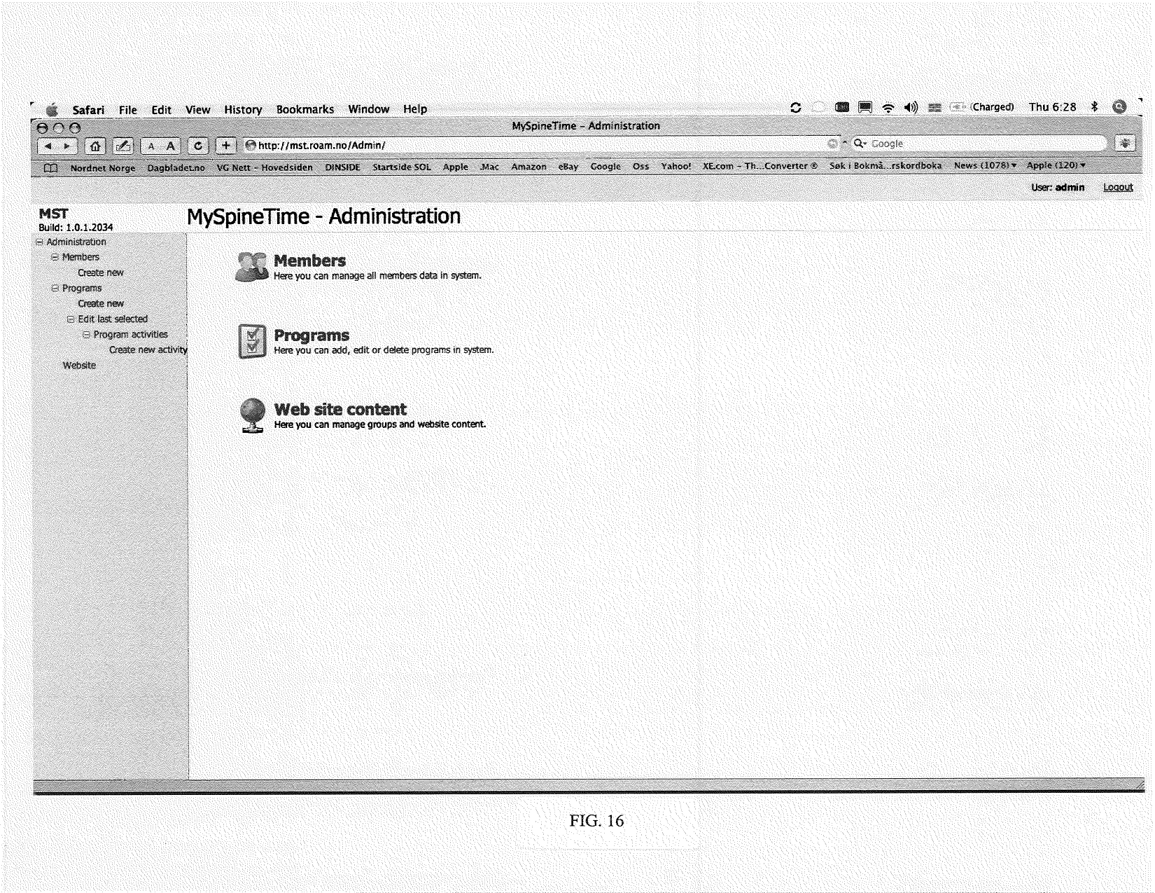

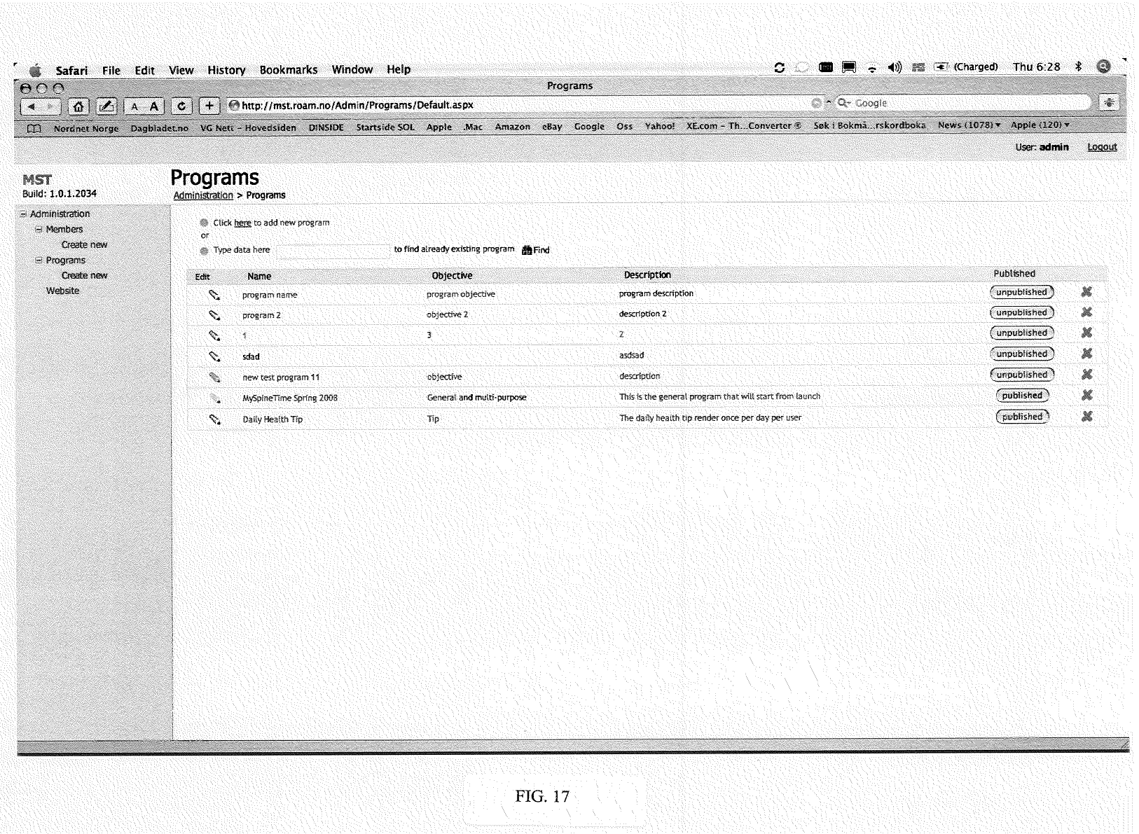

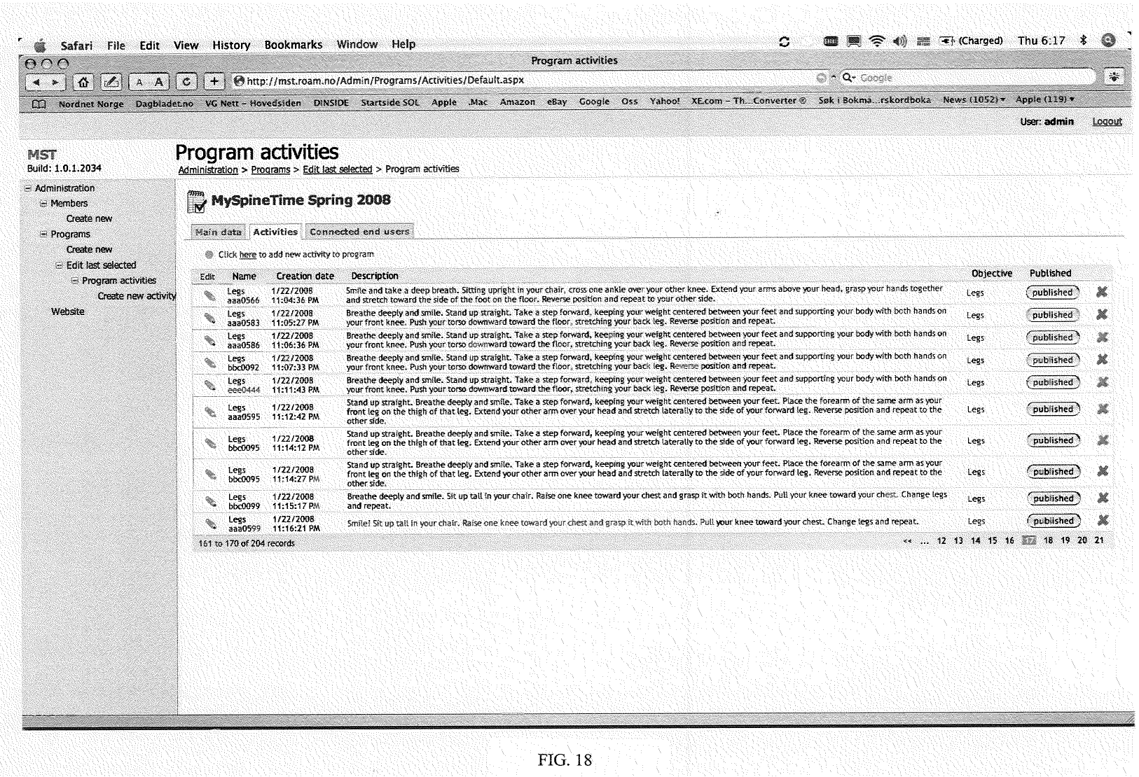

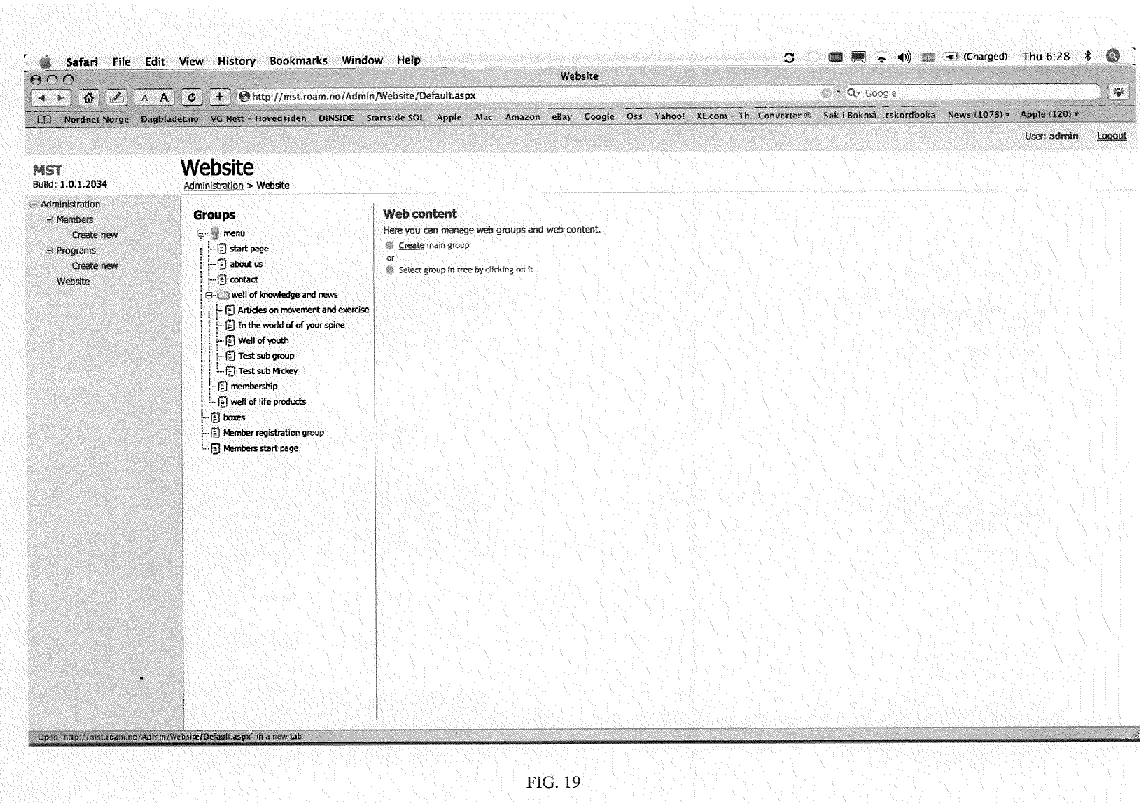

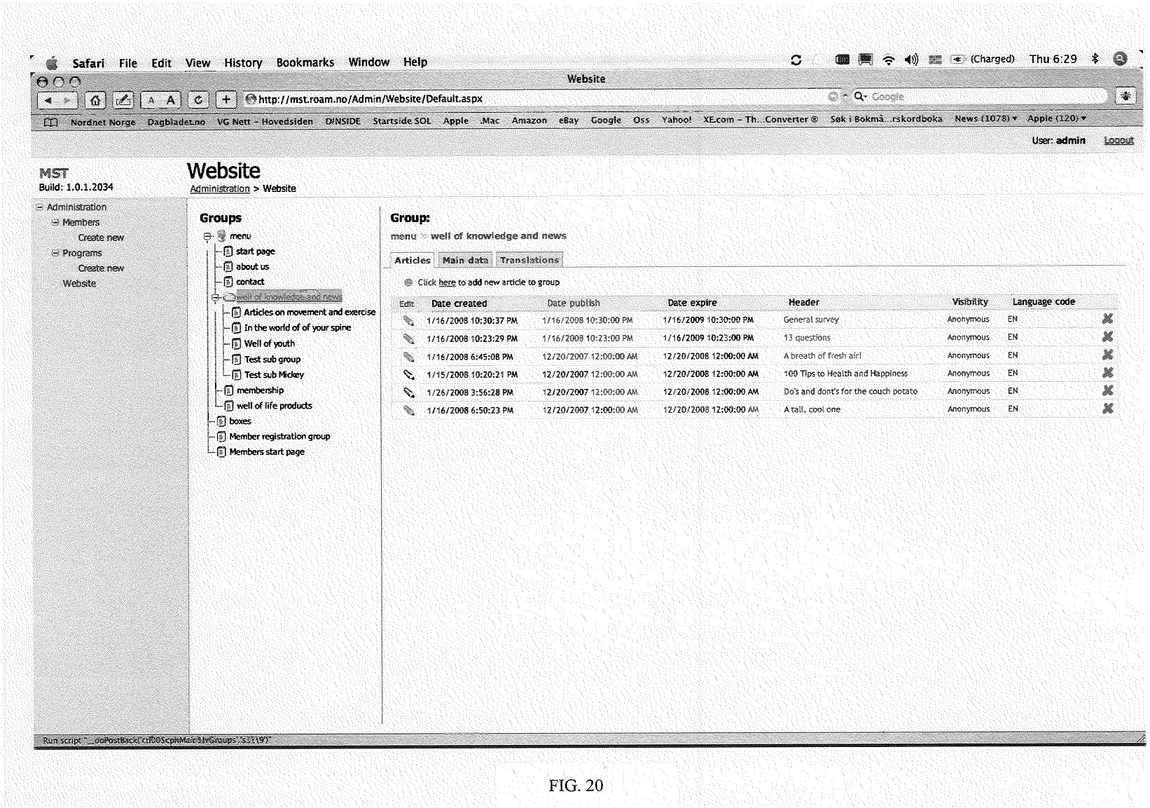

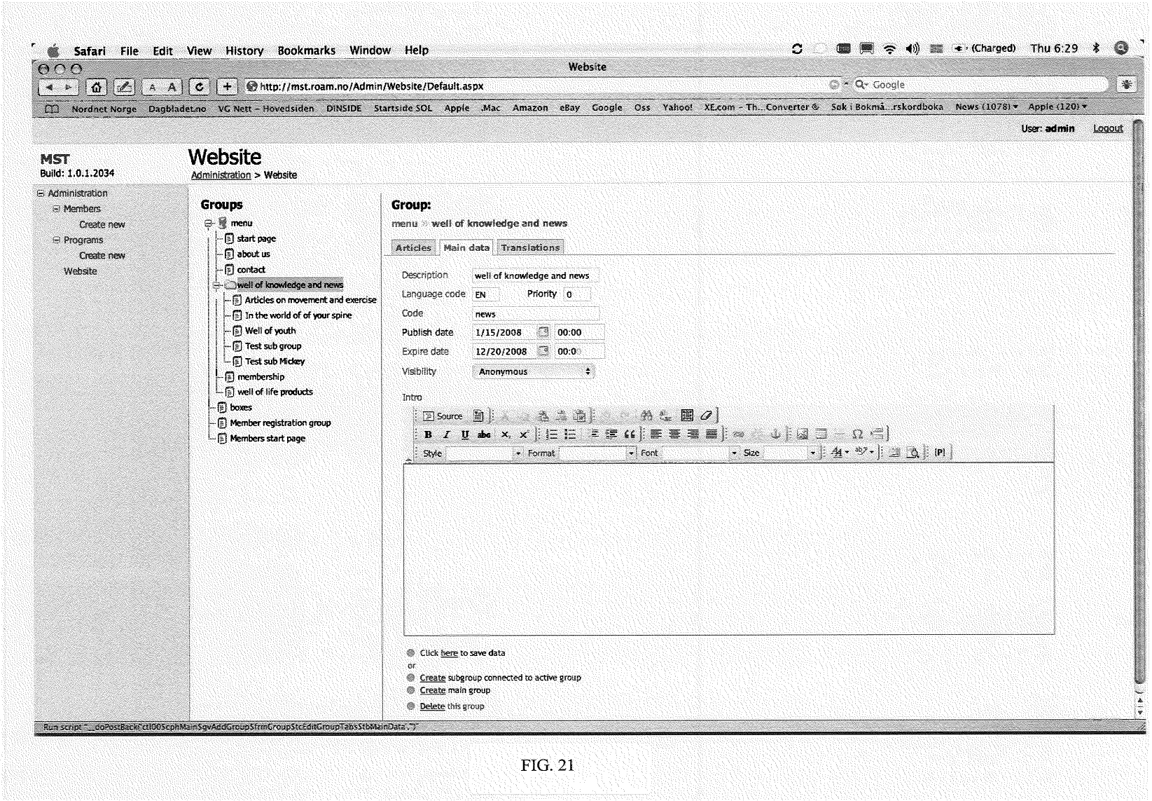

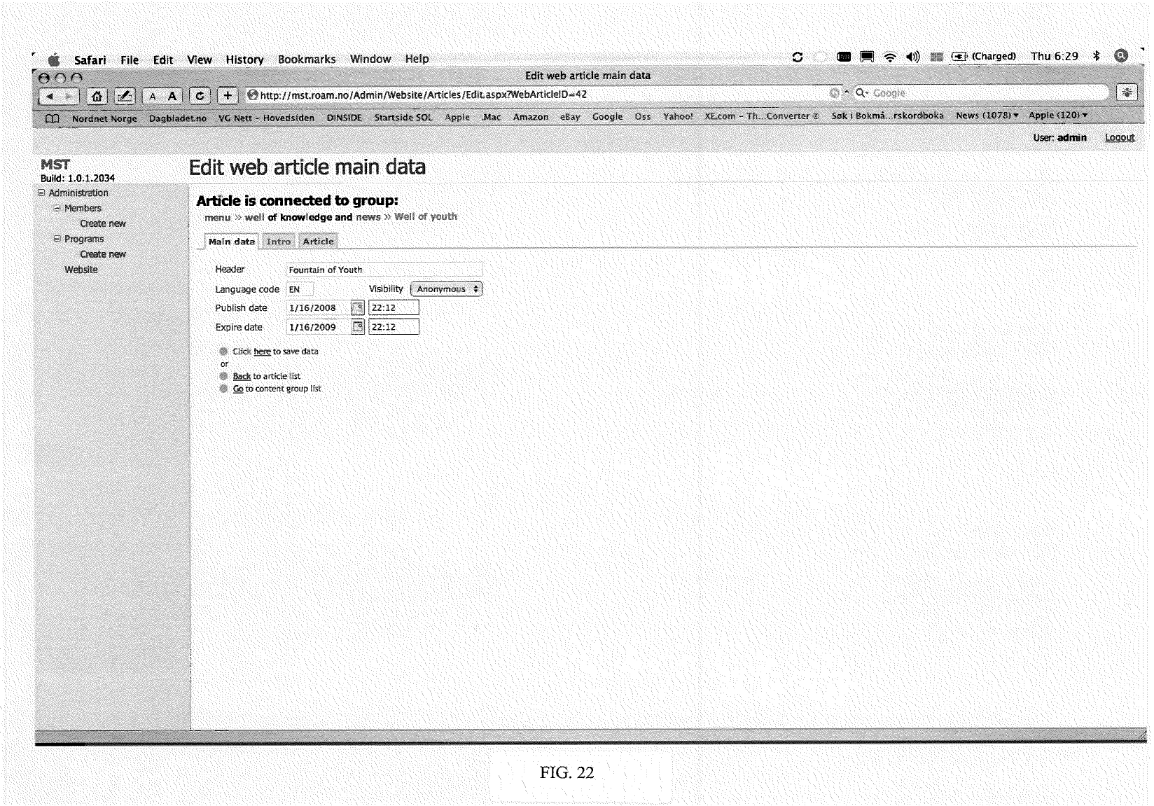

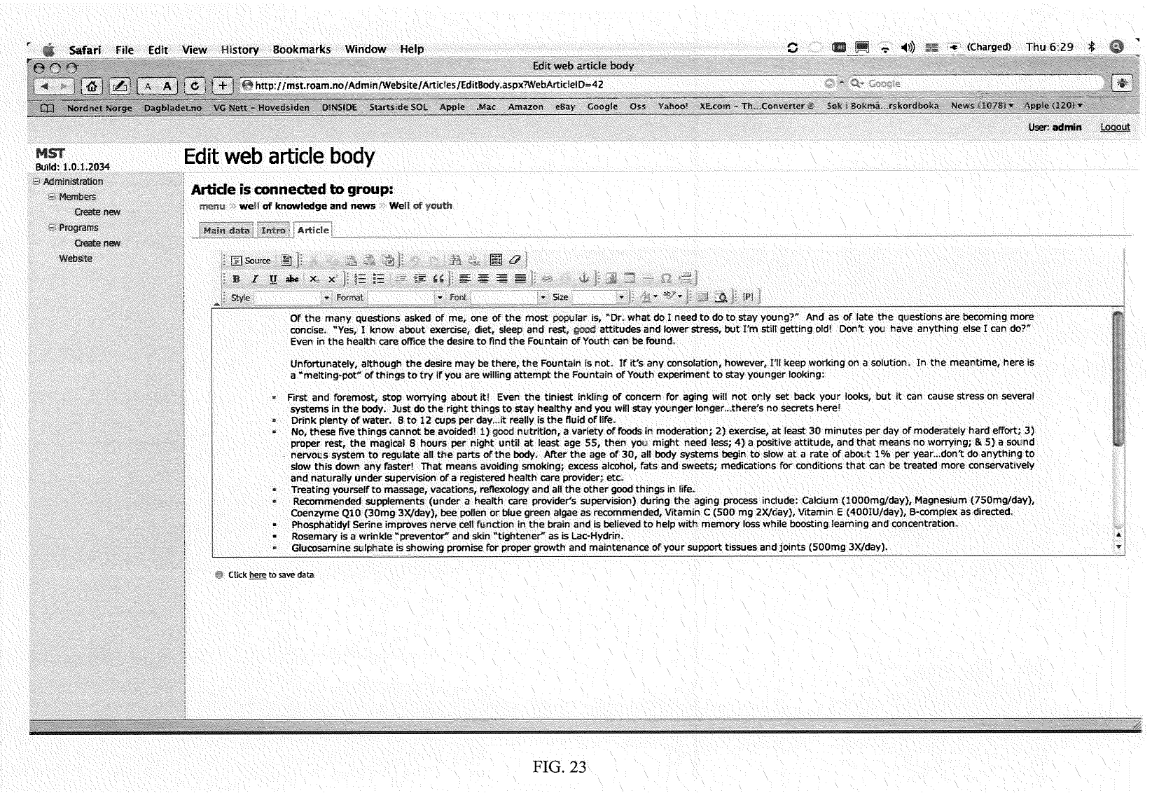

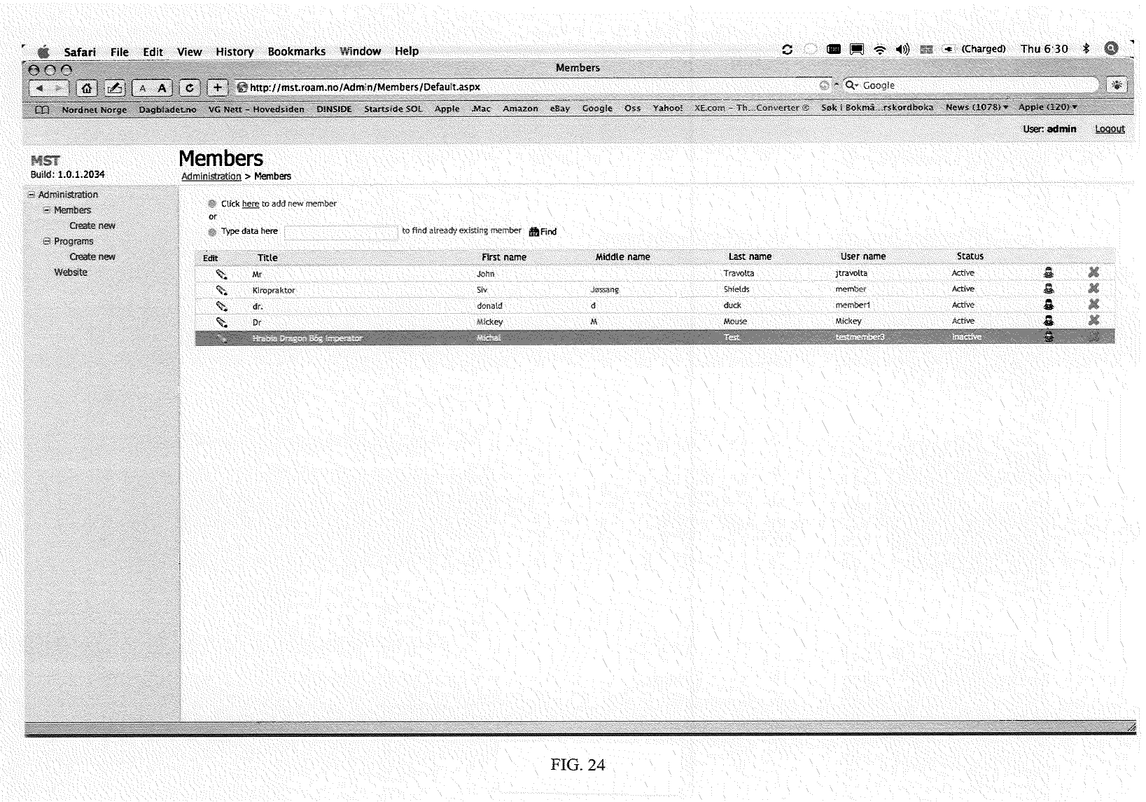

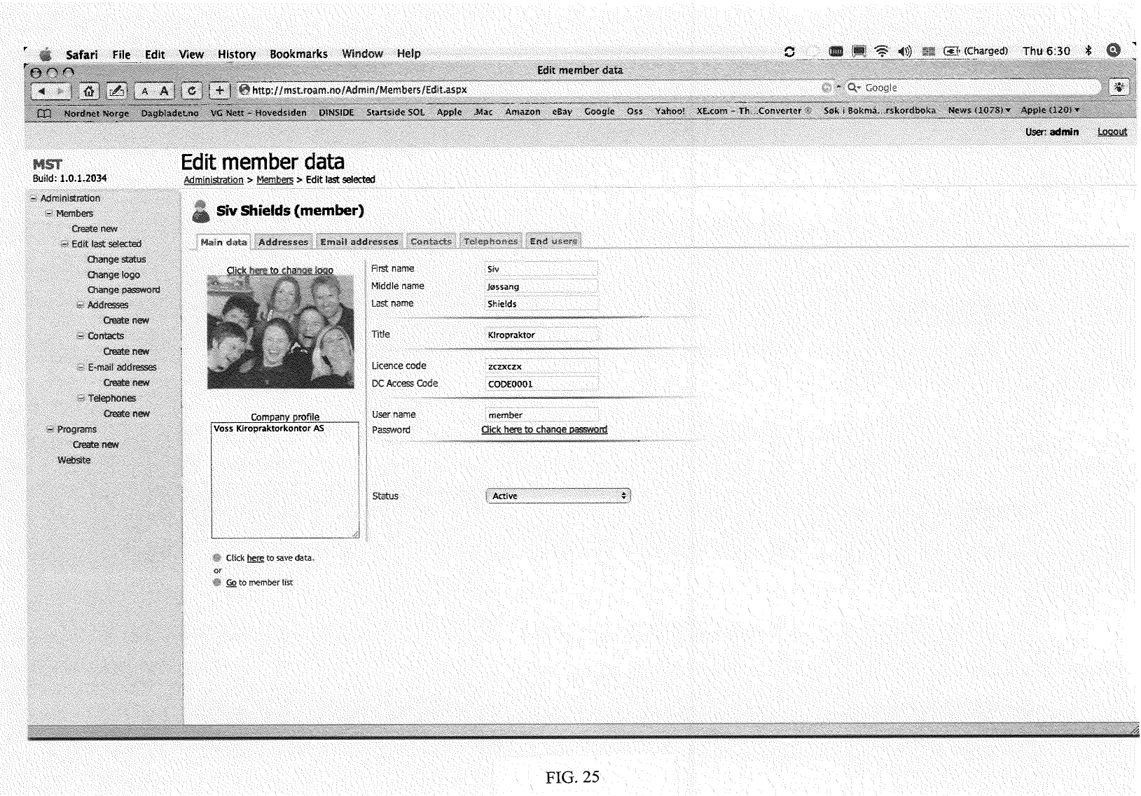

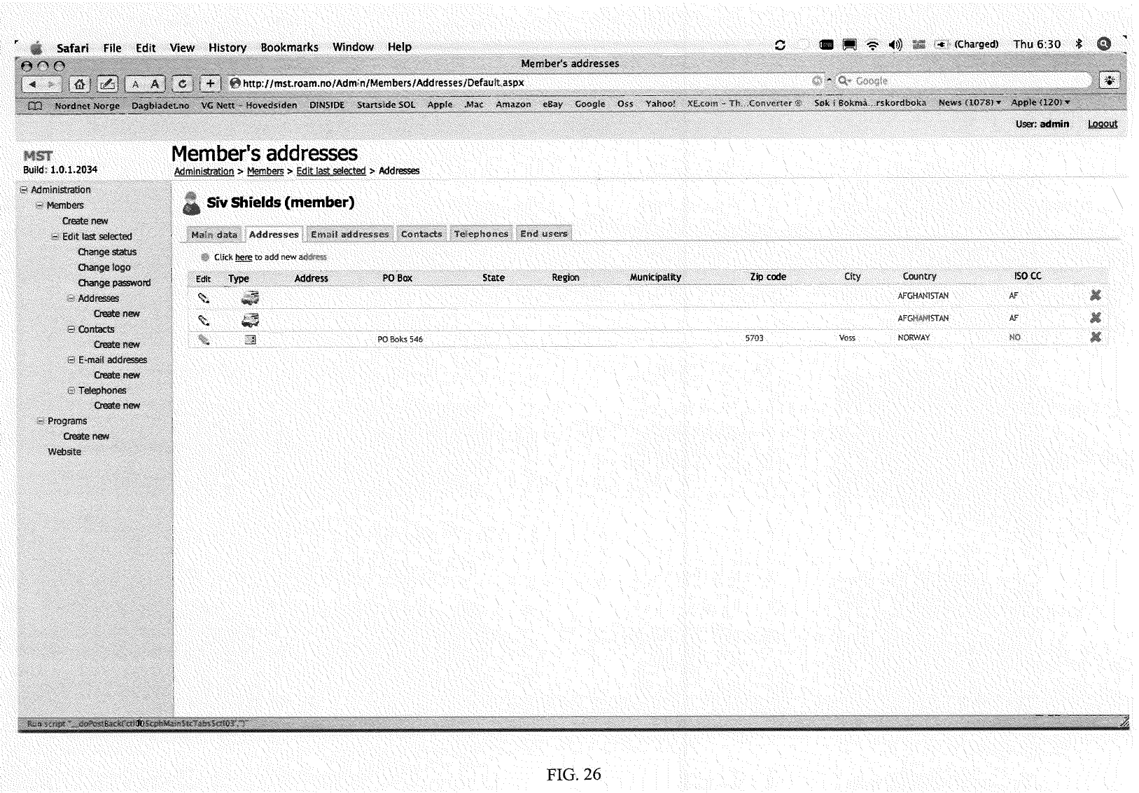

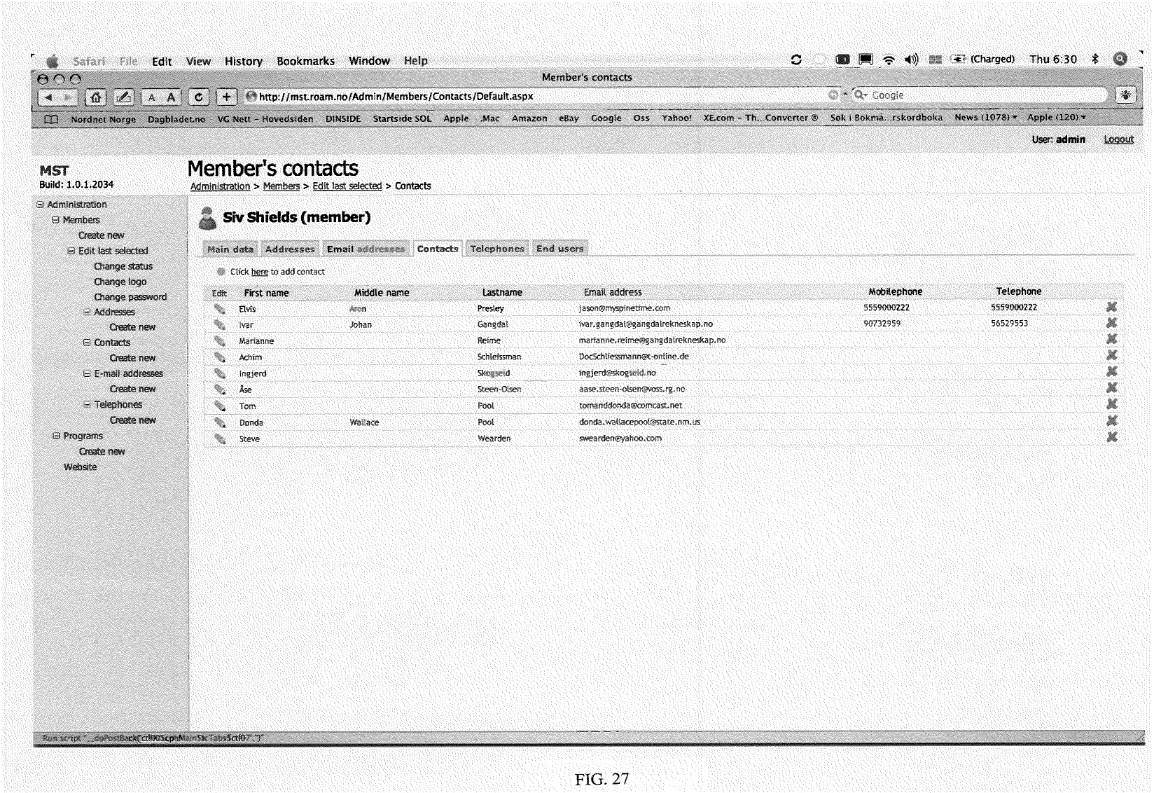

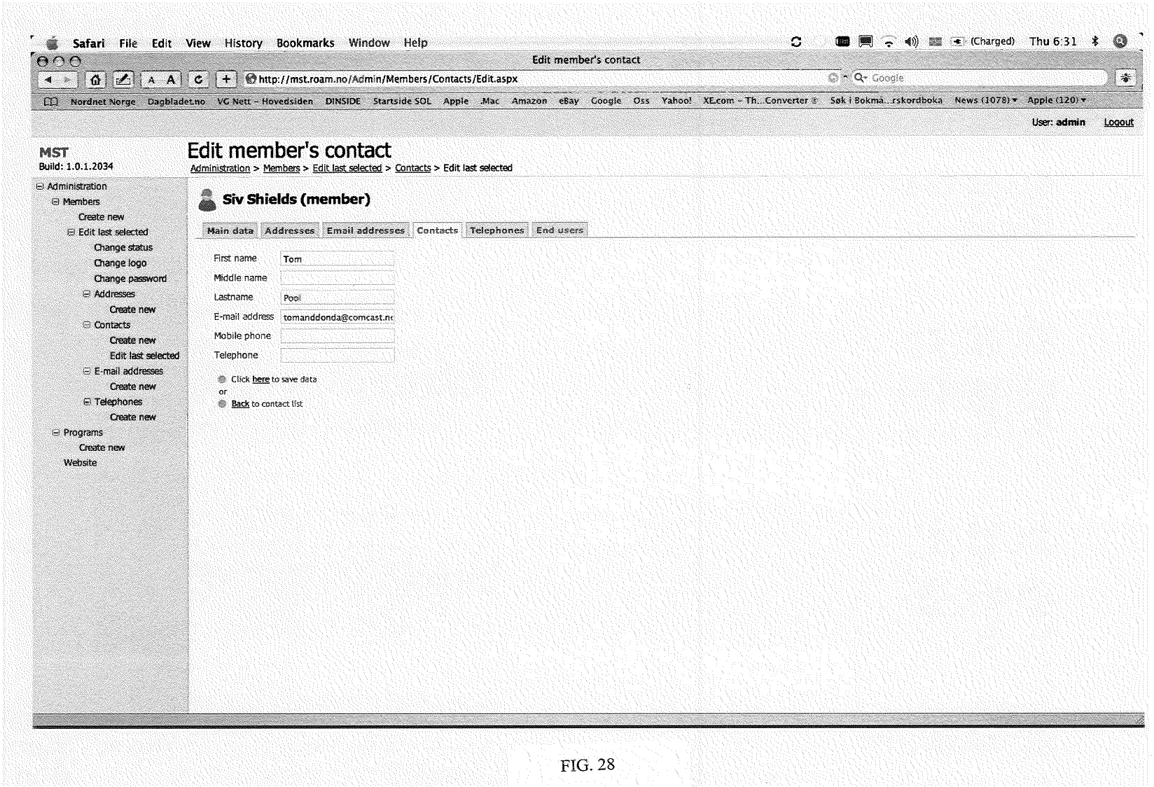

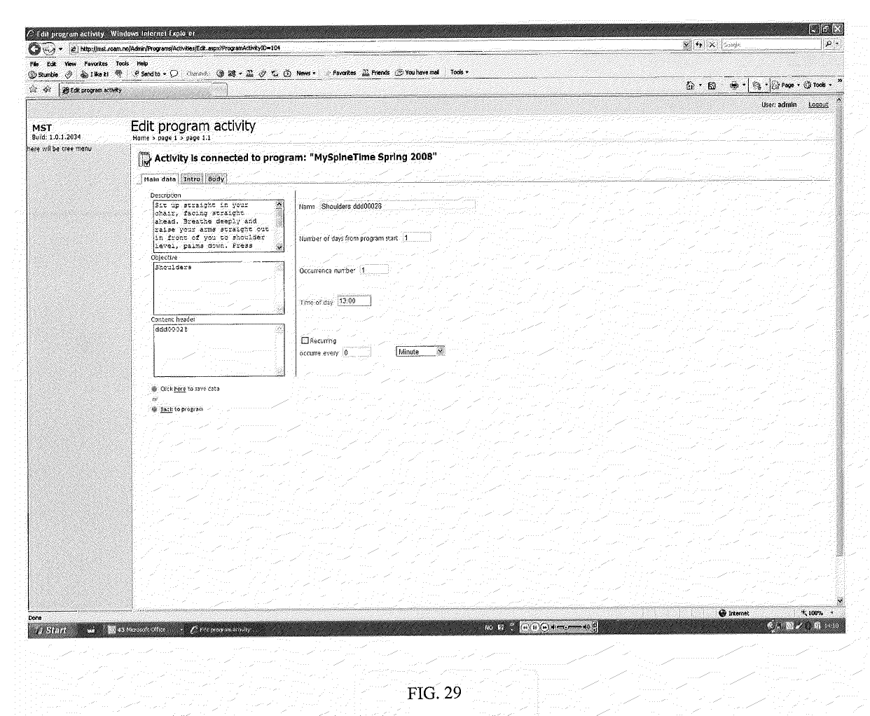

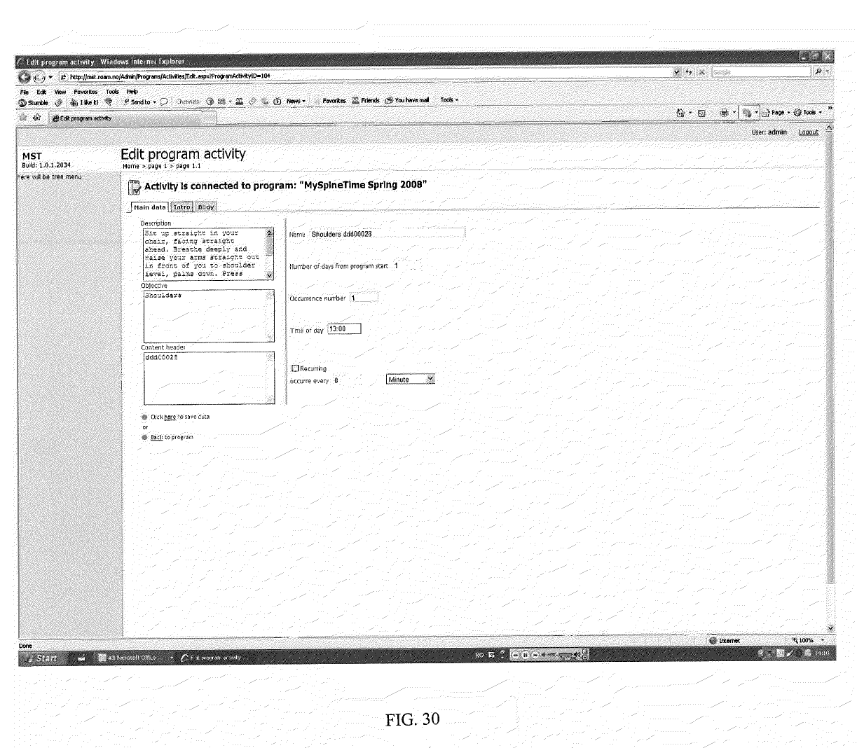

FIGS. 16-30 are screenshots of an example web site for administrators. An administrator can manage member data (e.g., doctor photos and text), add/modify/delete programs, manage groups, and add/modify/delete content such as health tips (graphics and/or text), wellness articles, mass communication content and settings, web shop products and prices, etc.

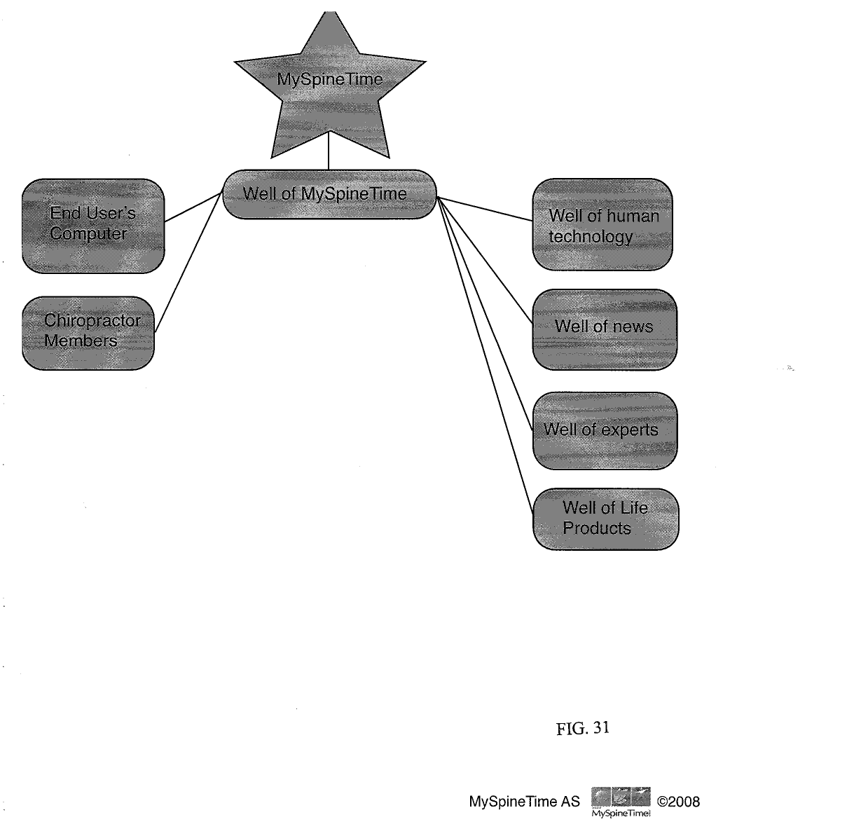

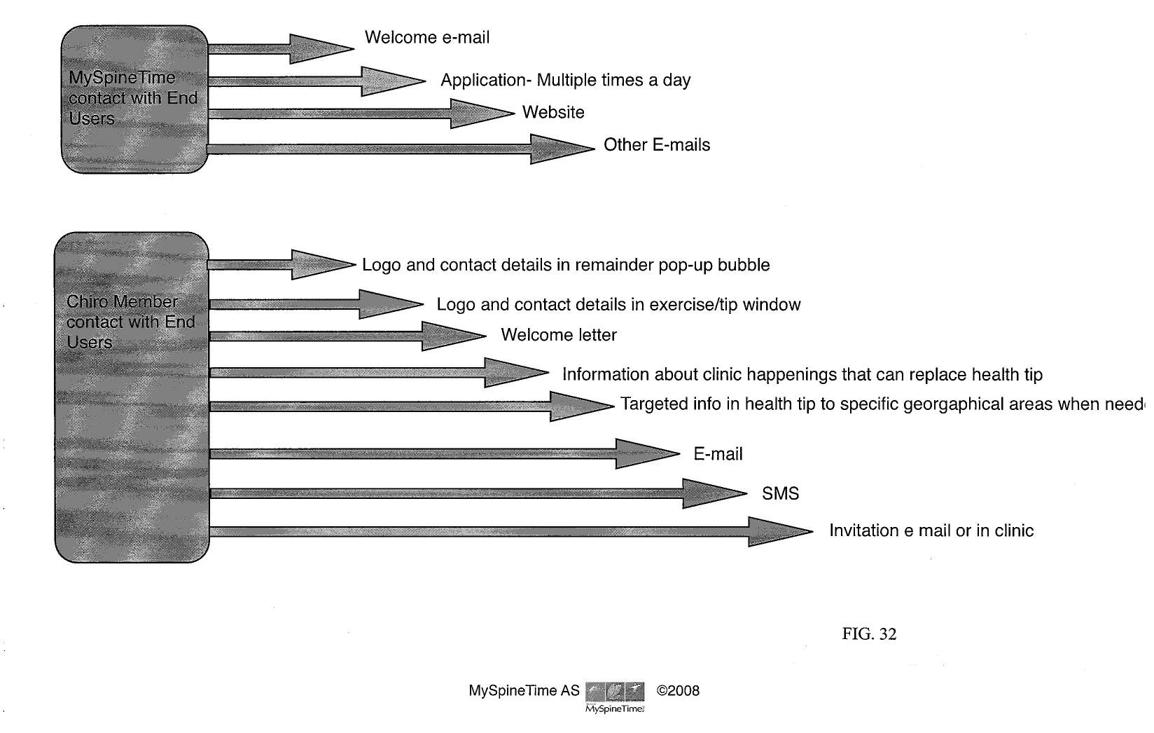

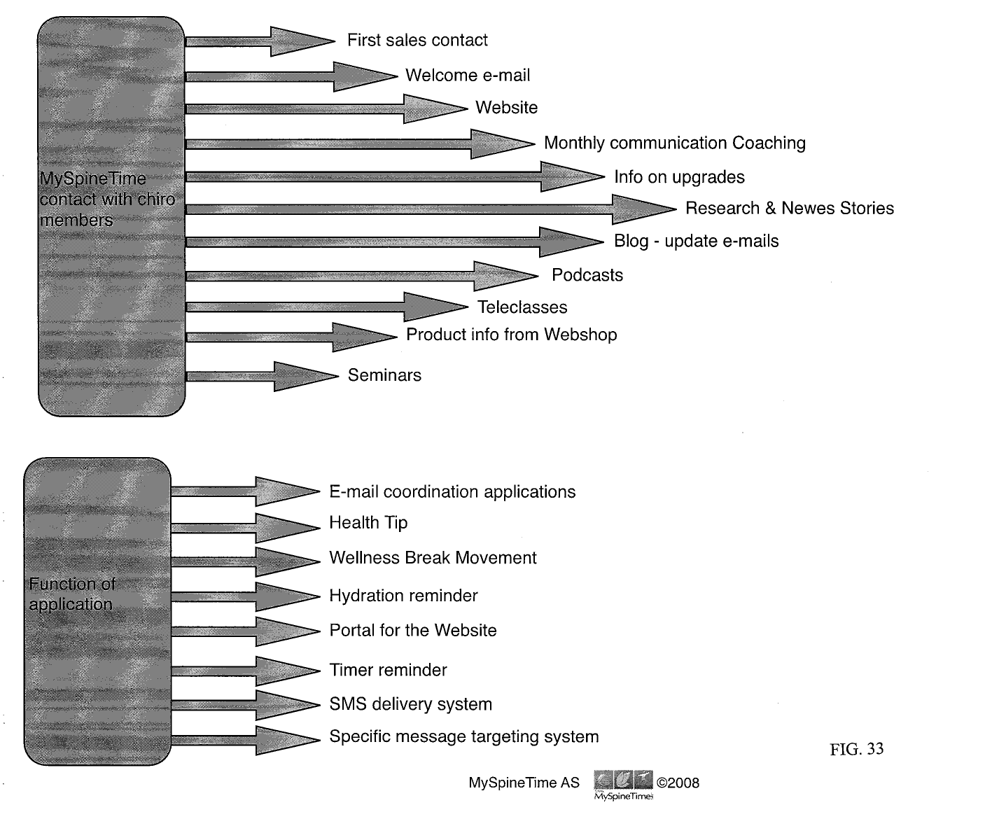

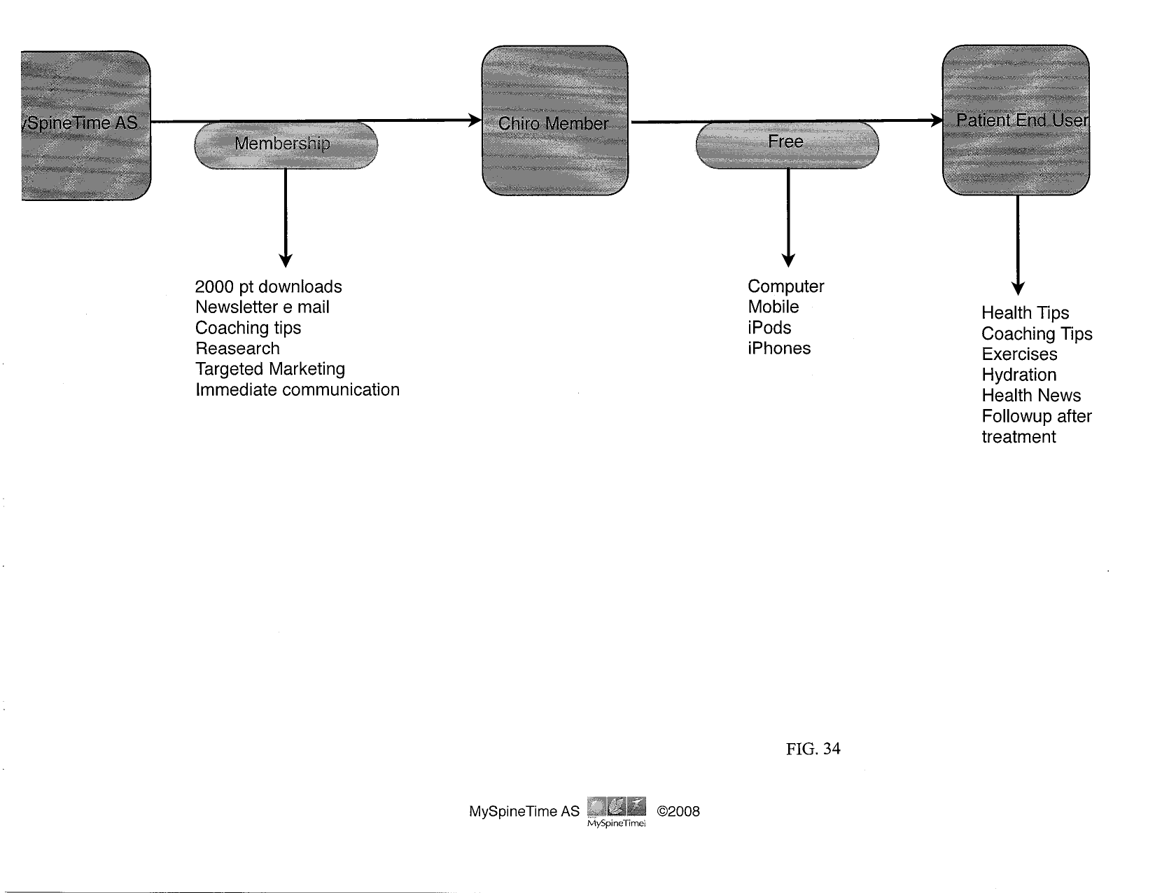

FIGS. 31-34 are block diagrams illustrating example system functionality. Various users and resources make up the example system, such as end users (e.g., chiropractic patients), doctors (e.g., chiropractors), human technology, news, experts, and life products. Each type of user may be sent different information. For example, end users (e.g., chiropractic patients) may be sent a welcome email, the wellness break software application (and associated health tips and other info), web pages, and other emails. Doctors (e.g., chiropractors) may be sent logo and contact details, a welcome letter, information about clinic happenings that can replace health tips, targeted information, emails, SMSs, and invitations, etc.

The following is an example doctor letter:

Dear Doctor
Thank you for your interest in MySpineTime™!
We have included a temporary pass code which will permit you access to the restricted area of our website, available only to our fellow chiropractors. In this area you will find helpful information to show you how MySpineTime™ can benefit you, your practice and your patients.
At MySpineTime™, we are striving to create a new wave in promoting chiropractic (and more specifically, your practice) and a chiropractic lifestyle—health, healing, movement and wellness awareness.
Remember Pavlov and his dogs? He conditioned them to think of food whenever they heard a bell ring. For more than a century, no matter what we might have wanted, we chiropractors have educated and conditioned our patients to think of us when they are in pain.
Our goal at MySpineTime™ is for your patients to realize that you want more for them than just being pain free. We want your patients to know and understand—as you do—the true value of chiropractic care.
We want your patients to think of you when—and because—they feel GREAT! And they want to feel better. And they want to come to you to get there. Your patients pay you to give them care. When you give them more than your “contract” with them requires, you create informed, appreciative and committed practice members who will want to share your message and your vision with their families and friends.
For the low annual membership subscription of $1,395, you can enroll your practice and give up to 2,000 of your closest friends, family and practice members free access to the MySpineTime™ program, where they will receive frequent, timely reminders to stretch, move, breathe and stay hydrated while working at their computer terminals-all with your name in front of the, linked to healthy living, several times every day.
In other words, for less than seventy cents per person, per year, your name and practice information will be present, linked to timely, valuable information about health and healthy living—from a chiropractic perspective—all day, every day to an audience that has already demonstrated an interest in chiropractic and confidence in you.
Imagine what this will do for your referrals, patient retention and PVA!
Imagine what this says about you to your patients and your community: “I care, even when I'm not there!”
We stand ready to answer your questions about MySpineTime™ and look forward to collaborating with you.
MySpineTime™ is in constant evolution. Over the coming weeks and months you will see a number of changes as we continue to add new features and value—for you and your practice.
Come along with us!
MySpineTime—a move to better health!™

The following is an example of doctor marketing material on the web site:
Here is how it works:
When you subscribe to MySpineTime™ you gain access to our website, where you can register your clinic. You will be given a unique passcode for your practice which you may then transmit to your patients. They can then down-load the MySpineTime™ web application to live on their desktop—for free!
Touch each patient every day
Your patients can choose how often to receive prompts to perform specific stretches and exercises throughout their workday.
These exercises are designed to put your patients' joints through appropriate ranges of motion, increasing your patients' sense of flexibility and vitality.
They will also be reminded to drink water at appropriate intervals, and they will become aware of bite-sized chunks of health and wellness information from the chiropractic perspective.
MySpineTime™ even includes relevant newsbytes on health and promoting well-being. Target Marketing
MySpineTime™ is a low cost, targeted way for you to send those all-important, reinforcing messages that say that change is possible and that you care about your patient's health, keeping them in your care and in your office.
Your patients have already said they are interested in chiropractic care by coming to your office in the first place. Keep them interested and committed by keeping them moving, educated and informed.

Building Patient Relationships
Your clinic's logo features prominently on the page; you can even post small messages about upcoming events in your office or even personal messages from you.
When those predictable nonsense stories appear in the media, MySpineTime™ will be right there—on your patients' desktop—with the facts, so that your patients can be secure that they are making the right choices in regard to their health.
   Developed by an elite team of education and communication experts and “million dollar practice” European/international chiropractors
   Affordable, innovative promotion of your practice to an audience that has already signalled their readiness to utilize chiropractic-your practice members
   Readily customizable to your patients' needs
   MySpineTime™—keeping your patients in care, even when you're not there Ask us about the $100 referral.

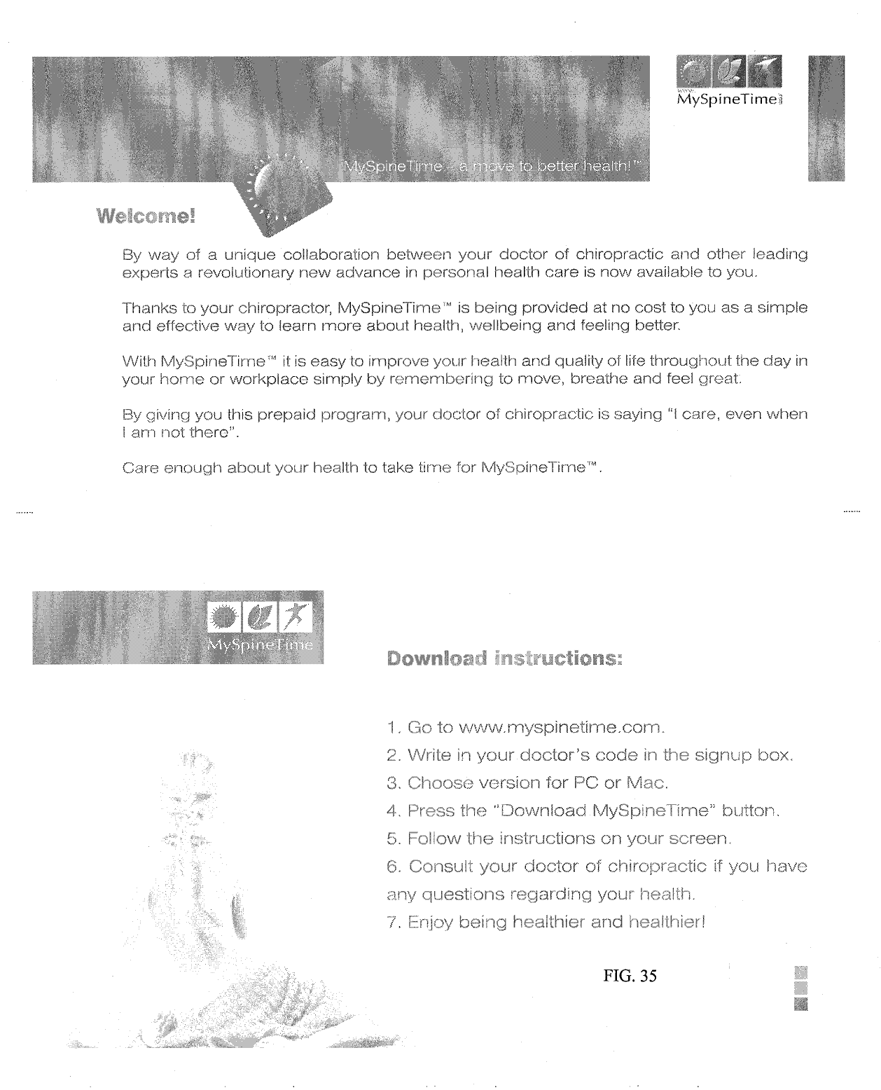

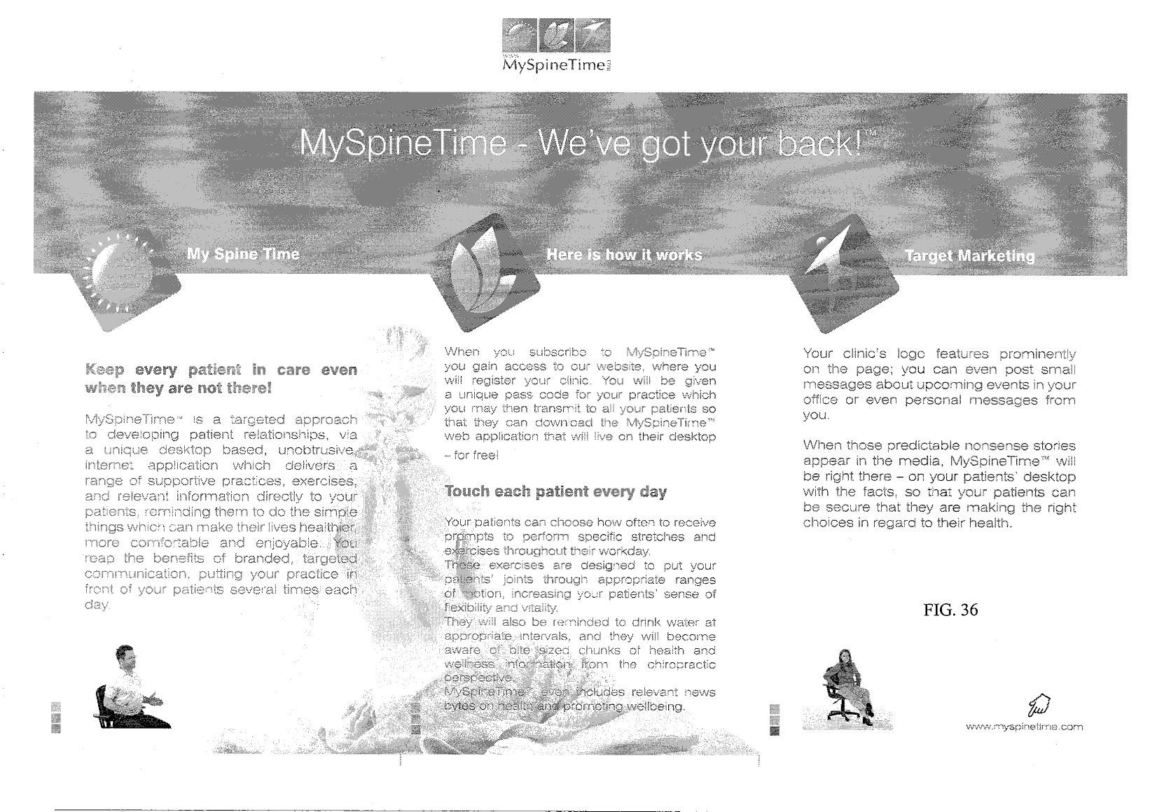

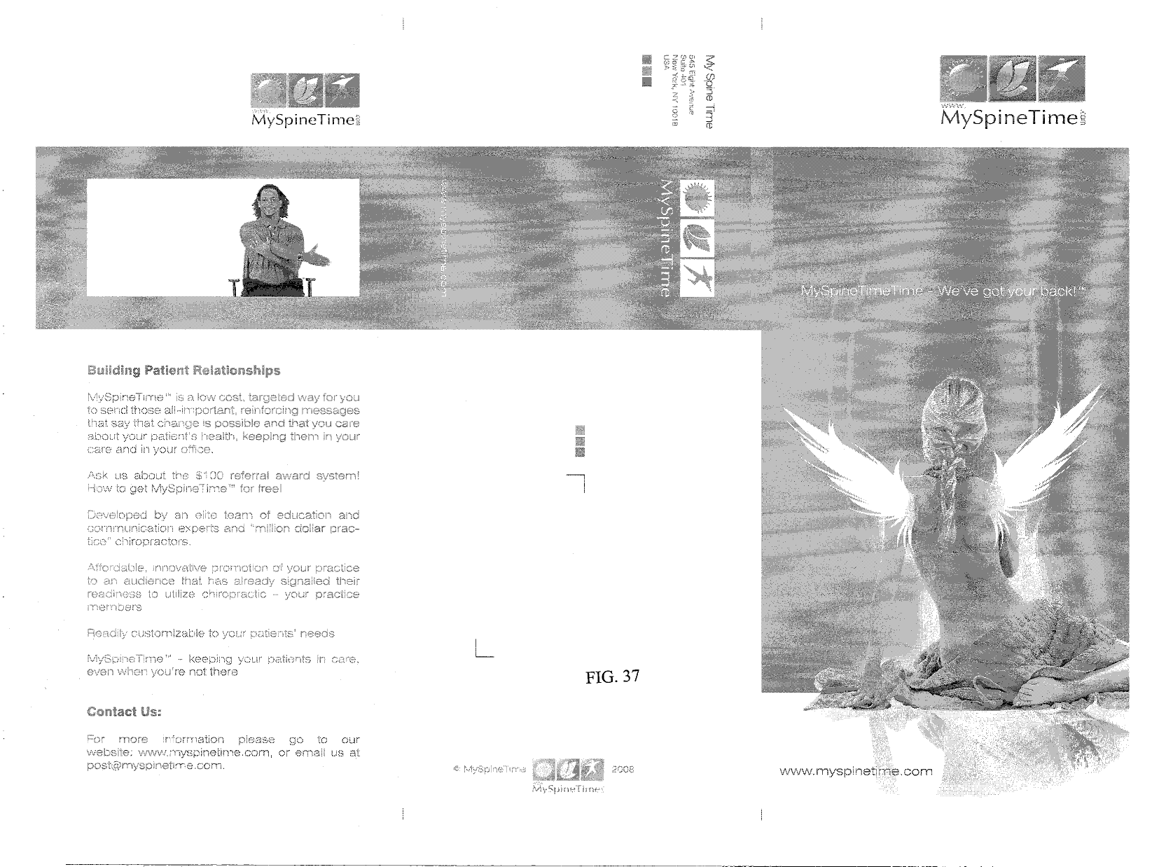

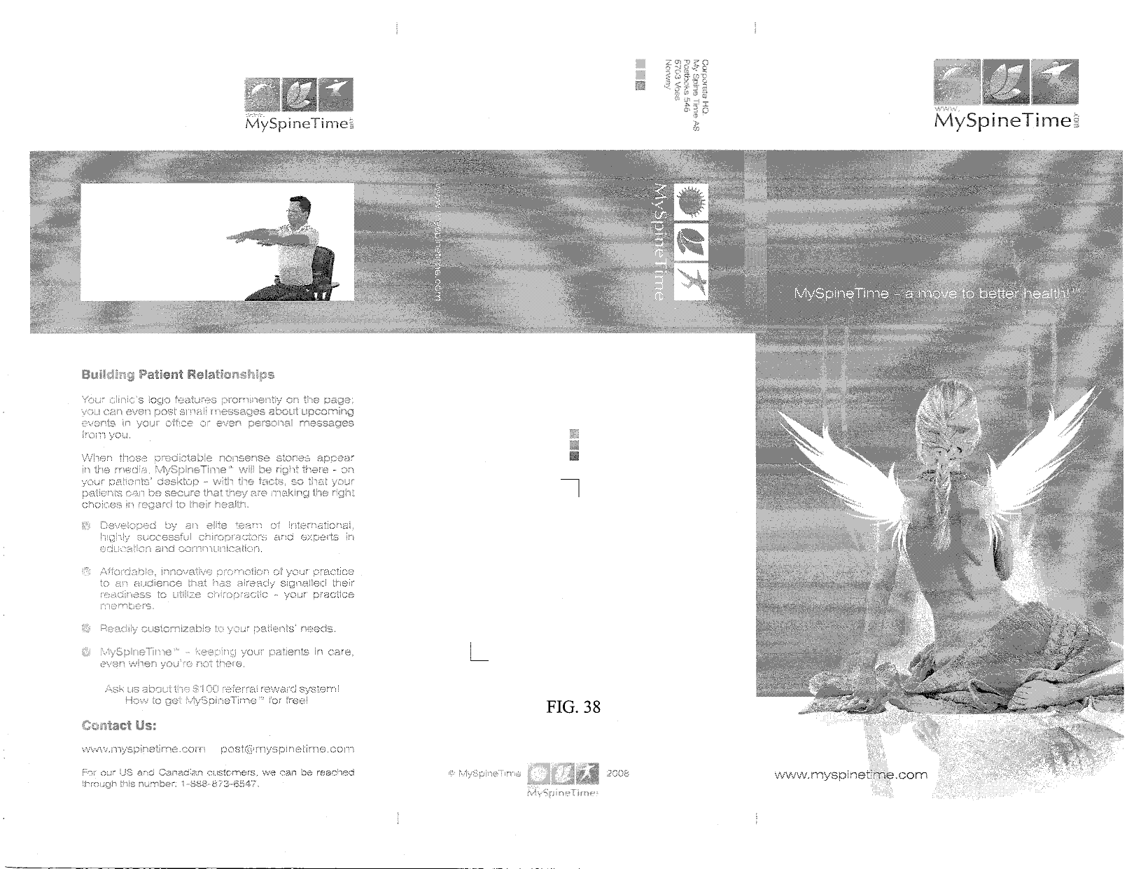

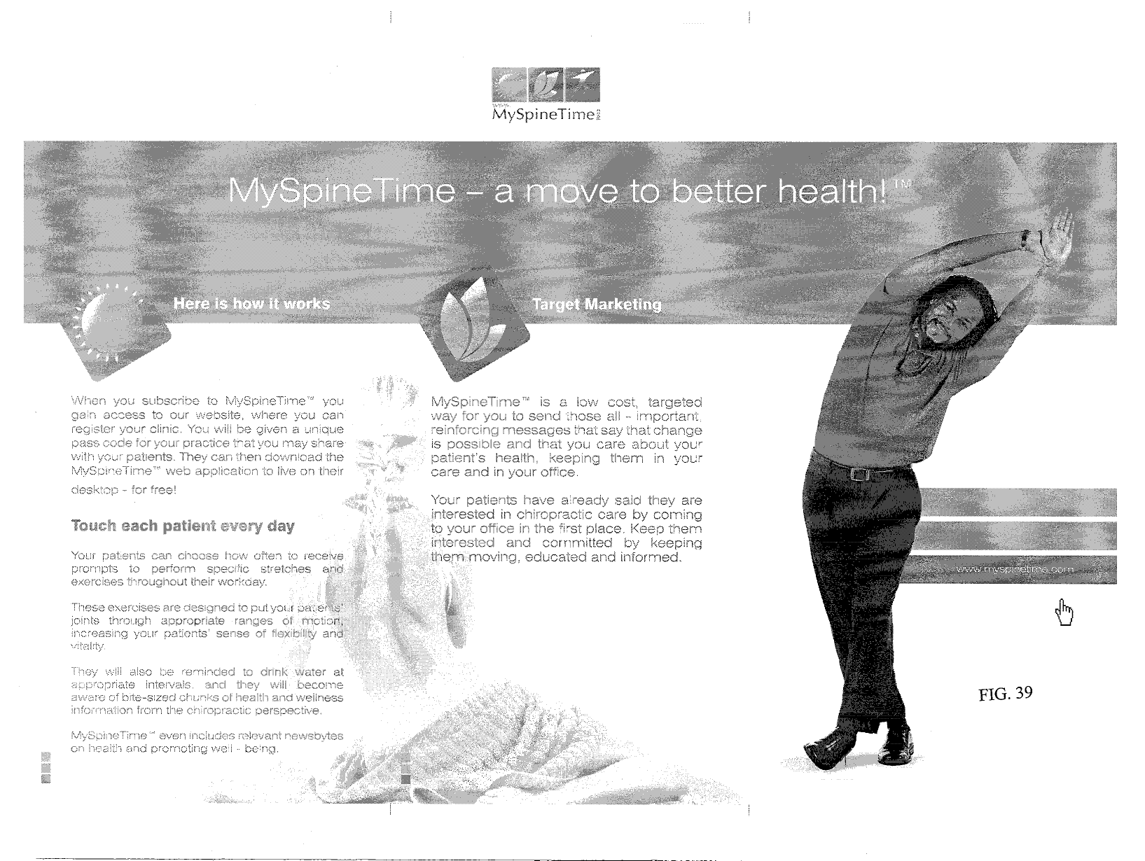

FIGS. 35-39 are examples of marketing materials. In this example, the marketing materials include a welcome message, download instructions, a system overview, a how-it-works section, target marketing information, relationship building information, and contact information.

In summary, persons of ordinary skill in the art will readily appreciate that methods and apparatus for communicating with chiropractic patients has been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of communicating with a chiropractic patient, the method comprising:
selling a membership to a chiropractor, the membership including (i) a license to download a plurality of copies of a wellness break software application from a hosting company and (ii) at least one access code associated with the wellness break software application;
providing the at least one access code to at least one of a patient and a prospective patient;
transmitting the wellness break software application from the hosting company to at least one of the patient and the prospective patient, the wellness break software application enabling at least one of the patient and the prospective patient to automatically receive a plurality of health tips, each health tip including a picture portion and a text portion, the picture portion illustrating at least one human body position, the text portion describing the at least one body position;
storing a user profile for at least one of the patient and the prospective patient, the user profile including scheduling information to facilitate a determination of when each of the health tips is delivered; and
transmitting the plurality of health tips from the hosting company to the wellness break software application to display the picture portion and the text portion for at least one of the patient and the prospective patient.

2. The method of claim 1, wherein the wellness break software application is a web based software application.

3. The method of claim 1, wherein the at least on access code is a single access code for the plurality of copies of the wellness break software application.

4. The method of claim 3, wherein the single access code is unique to this chiropractor.

5. The method of claim 1, wherein the at least on access code is a unique access code for each copy in the plurality of copies of the wellness break software application.

6. The method of claim 1, wherein the membership includes access to a chiropractic portion of a web site.

7. The method of claim 1, wherein the membership includes a portion of profits to the chiropractor from patient purchases at a web shop.

8. The method of claim 1, wherein the membership includes access to wellness articles.

9. The method of claim 1, wherein the membership mass patient communication.

10. The method of claim 9, wherein the mass patient communication uses email messages.

11. The method of claim 9, wherein the mass patient communication uses short messaging service (SMS) messages.

12. The method of claim 9, wherein the mass patient communication uses multimedia messaging service (MMS) messages.

13. The method of claim 1, wherein providing the at least one access code includes the chiropractor providing the at least one access code.

14. The method of claim 1, wherein providing the at least one access code includes a web based software application providing the at least one access code.

15. The method of claim 1, wherein providing the at least one access code includes providing the at least one access code to at least one patient and at least one prospective patient.

16. The method of claim 1, wherein providing the at least one access code includes providing the at least one access code at no charge.

17. The method of claim 1, wherein providing the at least one access code includes providing the at least one access code for a monetary fee.

18. The method of claim 1, wherein the picture portion includes a diagram.

19. The method of claim 1, wherein the picture portion includes a photograph.

20. The method of claim 1, wherein the wellness break software application enables at least one of the patient and the prospective patient access to a patient portion of a web site.

21. The method of claim 1, wherein the wellness break software application enables at least one of the patient and the prospective patient access to a web shop.

22. The method of claim 1, wherein the wellness break software application enables at least one of the patient and the prospective patient access to wellness articles.

23. The method of claim 1, wherein the wellness break software application enables at least one of the patient and the prospective patient access to receive mass patient communication.

24. The method of claim 23, wherein the mass patient communication includes email messages.

25. The method of claim 23, wherein the mass patient communication includes short messaging service (SMS) messages.

26. The method of claim 1, wherein at least one of the patient and the prospective patient are given a friends and family access code.

27. The method of claim 1, wherein each health tip is delivered to a personal computing device in the back ground as part of the personal computing device's operating system.

28. The method of claim 1, wherein each health tip is delivered via a web page.

29. The method of claim 1, wherein each health tip is delivered to a mobile device.

30. The method of claim 29, wherein the health tip is delivered via a short messaging service (SMS).

31. The method of claim 29, wherein the health tip is delivered via a multimedia messaging service (MMS) messages.

32. The method of claim 1, wherein the user profile includes time slots for when health tops should be delivered.

33. The method of claim 1, wherein the user profile includes number of health tips to be sent in a certain time period.

34. The method of claim 1, wherein the user profile includes a destination device for the health tips.

35. The method of claim 1, wherein the health tip is specific to at least one of the patient and the prospective patient.

36. The method of claim 1, wherein the health tip is not specific to at least one of the patient and the prospective patient.
